(19) United States
(12) Patent Application Publication
(10) Pub. No.: US 2026/0097488 A1
(43) Pub. Date: Apr. 9, 2026

(54) PLANNING AND CONTROL METHOD FOR LEGGED ROBOT, APPARATUS, ROBOT, AND STORAGE MEDIUM

(71) Applicant: TSINGHUA UNIVERSITY, Beijing (CN)

(72) Inventors: Mingguo ZHAO, Beijing (CN); Wenhan CAI, Beijing (CN); Yanbo PANG, Beijing (CN); Xinyu HAN, Beijing (CN)

(21) Appl. No.: 19/415,837

(22) Filed: Dec. 11, 2025

Related U.S. Application Data
(63) Continuation of application No. PCT/CN2024/070970, filed on Jan. 5, 2024.

(30) Foreign Application Priority Data
Nov. 13, 2023 (CN) 202311511514.9

(51) Int. Cl. B25J 9/16; B62D 57/032; G06N 3/008

(52) U.S. Cl. CPC B25J 9/1605; B25J 9/1664; B62D 57/032; G06N 3/008; G05B 2219/40511

(57) ABSTRACT

Provided are a planning and control method for a legged robot, an apparatus, a robot, and a storage medium. The method includes: determining, based on the movement state and the swing parameter of each leg at the next moment, a foot-end reference state of each leg, and planning, based on a foot-end dynamic model and a discrete collision model, an impact-aware swing leg trajectory for a leg that starts to swing at the next moment; and performing, based on the movement state, the reference state sequence, and the foot-end reference state, whole-body control on the legged robot, and performing, based on a whole-body dynamic model and the discrete collision model, impact-aware whole-body control for a leg that is a supporting leg in planning but does not touch the ground.

### CROSS-REFERENCE TO RELATED APPLICATION

The present application is a continuation of International Patent Application No. PCT/CN2024/070970, filed on Jan. 5, 2024, which claims priority to Chinese patent application No. 202311511514.9 filed on Nov. 13, 2023, the entire contents of which are incorporated herein by reference.

### FIELD

The present disclosure relates to the field of robot technologies, and more particularly, to a planning and control method for a legged robot, a planning and control apparatus for a legged robot, a robot, and a storage medium.

### BACKGROUND

A legged robot is developing rapidly. Many legged robots are no longer confined to static walking but are evolving towards faster, more agile, more robust, safer, and more multifunctional robots. When the legged robot performs a highly dynamic movement, an issue of a collision between a foot sole of the legged robot and the ground cannot be ignored.

In the related art, the legged robot can be regulated in terms of hardware and a control algorithm. In terms of the hardware, a foot pad with a certain degree of flexibility may be mount at the foot sole of the robot. Alternatively, a buffer device such as a spring-damper may be mounted at a driving joint of the robot. Alternatively, Variable Impedance Actuators (VIA) or Variable Stiffness Actuators (VSA) may be adopted to provide a desired passive mechanical impedance. In this way, an effect of changing a joint impedance at the mechanical level can be achieved, allowing a buffering effect to be adjusted as desired. In terms of the control algorithm, a contact velocity between the foot sole and the ground may be planned to approach zero in movement planning.

However, the methods in the related art have certain shortcomings. In terms of the hardware, introduction of a material may affect a response frequency of a robot system. Moreover, since stiffness, damping, and inertia characteristics of the material are constant, the buffering effect cannot be adjusted as desired. When using the VIA or the VSA, an overall structure is overly complex with a large volume and a large weight, making it difficult to apply such actuators to the legged robot that needs to perform the highly dynamic movement. In terms of the control algorithm, when the legged robot performs the highly dynamic movement, an actual movement trajectory of a swing leg may deviate significantly from a planned trajectory, resulting in premature ground contact or delayed ground contact of the foot sole. Therefore, an enormous foot-sole impact force may be generated, causing zero drift of the joint and accelerating hardware aging.

### SUMMARY

The present disclosure provides a planning and control method for a legged robot, a planning and control apparatus for a legged robot, a robot, and a storage medium, to solve problems in the related art such as limited passive flexible buffering for collision of the legged robot, a large computational load and low precision of a control algorithm, which causes accelerated hardware wear and a reduced service life of the robot, and a failure to meet practical application requirements.

An embodiment in a first aspect of the present disclosure provides a planning and control method for a legged robot. The method includes: obtaining a movement instruction and a movement state of the legged robot; generating, based on the movement instruction and the movement state, a reference state sequence of the legged robot and a swing parameter of each leg at a next moment; determining, based on the movement state and the swing parameter of each leg at the next moment, a foot-end reference state of each leg, and planning, based on a foot-end dynamic model and a discrete collision model, an impact-aware swing leg trajectory for a leg that starts to swing at the next moment, to enable an influence caused by an early collision to be within a target constraint range; and performing, based on the movement state, the reference state sequence, and the foot-end reference state, whole-body control on the legged robot, and performing, based on a whole-body dynamic model and the discrete collision model, impact-aware whole-body control for a leg that is a supporting leg in planning but does not touch the ground, to enable an influence caused by a delayed collision to be within the target constraint range.

In another exemplary embodiment of the present disclosure, the foot-end dynamic model is:

$${Λ}_{c , l} {\ddot{x}}_{c , l} + {h}_{c , l} = {F}_{j} ,$$

where \ddot{x}_{c,l}∈ [symbol] is a linear acceleration of a foot end of an l-th leg in an inertial system I, A_{c,l} is a mass matrix in an operation space, h_{c,l} is a term including a Coriolis force, a centripetal force, and a gravitational force in the operation space, and h_{c,l}∈ [symbol] is a foot-end driving force obtained by mapping a torque τⱼ of a driving joint to the operation space. The discrete collision model is:

$$Δ {\dot{x}}_{c , l} = {P}_{n} ( {\dot{x}}_{1}^{+} - {\dot{x}}_{1}^{-} ) = \to ( 1 + {c}_{r} ) {P}_{n} {\dot{x}}_{c , l}^{-} ,$$

where Pₙ=nn^{T}∈ [symbol] is a projection operator on a collision normal vector, n∈ [symbol] is a unit normal vector of a collision surface,

$${\dot{x}}_{1}^{+} , {\dot{x}}_{1}^{-} ∈$$

are a velocity of a first object before collision and a velocity of the first object after the collision respectively,

$${\dot{x}}_{2}^{+} , {\dot{x}}_{2}^{-} ∈$$

are a velocity of a second object before collision and a velocity of the second object after the collision respectively, and cᵣ is a restitution coefficient.

In another exemplary embodiment of the present disclosure, the planning, based on the foot-end dynamic model and the discrete collision model, the impact-aware swing leg trajectory includes: obtaining a pre-defined state variable and a target constraint condition; constructing, based on the foot-end dynamic model, the pre-defined state variable, and the target constraint condition, a continuous-time trajectory optimization problem for the leg that starts to swing at a next moment; and discretizing the continuous-time trajectory optimization problem to obtain a discrete-time trajectory optimization problem for a foot end of a swing leg, and solving the discrete-time trajectory optimization problem to obtain the impact-aware swing leg trajectory.

In another exemplary embodiment of the present disclosure, the pre-defined state variable includes one or more of: an initial state of the foot end of the swing leg, a touchdown state of the foot end of the swing leg, a swing duration, and a desired maximum height of the foot end of the swing leg from the ground. The target constraint condition includes one or more of: a state equation equality constraint, a driving force inequality constraint, a trajectory height inequality constraint, an initial state equality constraint, a terminal state equality constraint, an impact-aware inequality constraint, and a terminal velocity direction inequality constraint.

In another exemplary embodiment of the present disclosure, an objective function of the continuous-time trajectory optimization problem is:

$${min}_{x ( t ) , u ( t )} {f}_{TO} = {‖ x ( {t}_{F} ) - [ \begin{matrix}{x}_{c , F}^{ref} \\ {\dot{x}}_{c , F}^{ref}\end{matrix} ] ‖}_{{Q}_{{x}_{F}}} + {\int }_{{t}_{0}}^{{t}_{F}} {‖ u ( τ ) ‖}_{{Q}_{u}} d τ + {\int }_{{t}_{{h}_{1}}}^{{t}_{{h}_{2}}} {‖ {z}_{c} ( τ ) - {z}_{h}^{ref} ‖}_{{Q}_{z}} d τ ,$$

where Qₓ_{_{F}}∈ [symbol] , Qᵤ∈ [symbol] , and Q_{z}∈ [symbol] are weight matrices (mostly diagonal matrices) with different dimensions, ∥a∥_{Q}=a^{T}Qa represents a weighted norm of a vector a under a weight matrix

$$Q , {‖ x ( {t}_{F} ) - [ \begin{matrix}{x}_{c , F}^{ref} \\ {\dot{x}}_{c , F}^{ref}\end{matrix} ] ‖}_{{Q}_{{x}_{F}}}$$

reflects a task of a touchdown state of the foot end of the swing leg,

$${x}_{c , F}^{ref}$$

∈ [symbol] and

$${\dot{x}}_{c , F}^{ref}$$

∈ [symbol] are a known terminal position of the foot end of the swing leg and a known linear velocity of the foot end of the swing leg respectively,

$${\int }_{{t}_{0}}^{{t}_{F}} {‖ u ( τ ) ‖}_{{Q}_{u}} d τ$$

is a minimum control variable (i.e., a linear acceleration) in an entire swing process, and t₀=0, t_{F}=T_{sw}, where T_{sw} is a swing duration,

$${\int }_{{t}_{{h}_{1}}}^{{t}_{{h}_{2}}} {‖ {z}_{c} ( τ ) - {z}_{h}^{ref} ‖}_{{Q}_{z}}$$

dτ reflects a task of a maximum height of the swing leg from the ground, tₕ₁ and tₕ₂ are parameters specifying a time period to reach the maximum height, satisfying t₀≤tₕ₁≤tₕ₂≤t_{F}, and z_{c} is a third component of the state variable, i.e., a component representing a height of the foot end from the ground in the state variable. The discrete-time trajectory optimization problem is:

$${min}_{U} {f}_{c , TO} = {‖ {x}_{N} - {x}_{N}^{ref} ‖}_{{Q}_{{x}_{N}}} + {\sum }_{k = 0}^{N - 1} {‖ {u}_{k} ‖}_{{Q}_{{u}_{k}}} + {\sum }_{k = {k}_{{h}_{1}}}^{{k}_{{h}_{2}}} {‖ {S}_{z} {x}_{k} - {z}_{h}^{ref} ‖}_{{Q}_{{z}_{k}}} ,$$

$$s . t . {\underbrace{[ \begin{matrix}{x}_{c , k + 1} \\ {\dot{x}}_{c , k + 1}\end{matrix} ]}}_{{x}_{k + 1}} = {\underbrace{[ \begin{matrix}{I}_{3 \times 3} & Δ t {I}_{3 \times 3} \\ {0}_{3 \times 3} & {I}_{3 \times 3}\end{matrix} ]}}_{A} {\underbrace{[ \begin{matrix}{x}_{c , k + 1} \\ {\dot{x}}_{c , k + 1}\end{matrix} ]}}_{{x}_{k}} + {\underbrace{[ \begin{matrix}\frac{1}{2} Δ {t}^{2} {I}_{3 \times 3} \\ Δ t {I}_{3 \times 3}\end{matrix} ]}}_{B} {\underbrace{{\ddot{x}}_{c , k}}}_{{u}_{k}} , k = 0 , 1 , … , N - 1 ,$$

$${f}_{min} \leq {Λ}_{c} {u}_{k} + {h}_{c} \leq {f}_{max} , k = 0 , 1 , … , N - 1 ,$$

$${z}_{c , min} \leq {S}_{z} {x}_{k} \leq {z}_{c , max} , k = 1 , 2 , … , N - 1 ,$$

$${x}_{0} = {x}_{0}^{fb} ,$$

$${S}_{Z , \dot{Z}} {x}_{N} = {S}_{Z , \dot{Z}} {x}_{N}^{ref} ,$$

$${ι}_{c , min} ⩽ {Λ}_{c} [ - ( 1 + {c}_{r} ) {P}_{n} {S}_{v} {x}_{k} ] ⩽ {ι}_{c , max} , k = {k}_{imp} , {k}_{imp} + 1 , … , N ,$$

$$( {C}_{{ℓ}_{1}} + \frac{1}{cos {θ}_{c , max}} {D}_{n} ) {S}_{v} {\dot{x}}_{k} \leq {0}_{4 \times 1} , k = {k}_{imp} , {k}_{imp} + 1 , … , N ,$$

where

$$U = {[ {u}_{0}^{T} , {u}_{1}^{T} , … , {u}_{N - 1}^{T} ]}^{T} ∈$$

is a vector composed of a control variable of each frame, Qₓ_{_{N}}∈ [symbol] , Qᵤ_{ₖ}∈ [symbol] , and Q_{z}_{ₖ}∈ [symbol] are diagonal weight matrices with different dimensions,

$${x}_{0}^{fb} = [ \begin{matrix}{x}_{c , 0}^{fb} \\ {\dot{x}}_{c , 0}^{fb}\end{matrix} ] ∈$$

is a feedback of a foot-end state (including a position and a velocity) at a current moment,

$${x}_{N}^{ref} = [ \begin{matrix}{x}_{c , F}^{ref} \\ {\dot{x}}_{c , F}^{ref}\end{matrix} ] ∈$$

is a reference terminal foot-end state (including the position and the velocity), S_{ν}=[0_{3×3}I_{3×3}]∈ [symbol] is a selection matrix of a foot-end linear velocity, kₕ_{₁} and kₕ_{₂} are an artificially specified start frame and an artificially specified end frame for maintaining a swing height, satisfying 0<kₕ_{₁}≤kₕ_{₂}<N, and kᵢₘₚ is a start frame for enabling an impact-aware constraint and a terminal velocity direction constraint, satisfying 0≤kᵢₘₚ≤N.

In another exemplary embodiment of the present disclosure, an optimization problem of the whole-body control is:

$${min}_{χ} {\sum }_{i = 1}^{{n}_{task}} {‖ {W}_{i} ( {A}_{i} χ - {b}_{i} ) ‖}_{2}^{2} ,$$

$$s . t . {lb}_{j} \leq {C}_{j} χ \leq {ub}_{j} , j = 1 , 2 , … , {n}_{constraint} ,$$

where Aᵢ is a task matrix, bᵢ is a task vector, cⱼ is a constraint matrix, lbⱼ and ubⱼ are a lower constraint bound and an upper constraint bound, Wᵢ is a weight matrix, nₜₐₛₖ is a quantity of tasks, and n_{constraint} is a quantity of constraints.

In another exemplary embodiment of the present disclosure, tasks processed simultaneously by the whole-body control include two or more of: a trunk trajectory tracking task, a foot-end trajectory tracking task, a foot-sole force tracking task, a task of minimizing variation of a joint torque, and a task of minimizing variation of a foot-sole force. Constraints processed simultaneously by the impact-aware whole-body control include two or more of: a floating-base dynamic equality constraint, a foot-sole force inequality constraint, a joint output torque saturation inequality constraint, a joint rotational speed saturation inequality constraint, a joint output power saturation inequality constraint, and an impact-aware constraint.

In another exemplary embodiment of the present disclosure, the performing, based on the movement state, the reference state sequence, and the foot-end reference state, whole-body control on the legged robot includes: if a leg is a swing leg in planning, setting the foot-end trajectory tracking task as tracking the impact-aware swing leg trajectory, setting a target foot-sole force of the foot-sole force tracking task as a predetermined value, setting a foot-sole force constraint in the foot-sole force inequality constraint as a predetermined value, and disabling the impact-aware constraint; if a leg is the supporting leg in planning and touches the ground, setting a target linear acceleration of the foot-end trajectory tracking task as a predetermined value, setting the target foot-sole force of the foot-sole force tracking task as a foot-sole force provided by Model Predictive Control (MPC) or another module, setting the foot-sole force constraint as a friction cone constraint, and disabling the impact-aware constraint; and if a leg is a supporting leg in planning but does not touch the ground, setting a target of the foot-end trajectory tracking task as tracking a velocity pointing to an collision surface, setting the target foot-sole force of the foot-sole force tracking task as a predetermined value, setting the foot-sole force constraint as a predetermined value, and enabling the impact-aware constraint.

In another exemplary embodiment of the present disclosure, the whole-body dynamic model is:

$$M ( {q}_{q} ) \ddot{q} + h ( {q}_{g} , \dot{q} ) = [ \begin{matrix}{0}_{6 \times 1} \\ {τ}_{j}\end{matrix} ] + {J}_{c}^{T} ( {q}_{g} ) {F}_{c} ,$$

where M(q_{g})∈ [symbol] is a generalized mass matrix, h(q_{g},\dot{q})∈ [symbol] is a term including a Coriolis force, a centripetal force, and a gravitational force, τⱼ∈ [symbol] represents an output torque of a driving joint, 0_{n×n} represents a zero matrix with a size of n×m,

$${J}_{c}^{T} ( {q}_{g} )$$

and F_{c} are an augmented Jacobian matrix formed by stacking a contact Jacobian matrix of each supporting leg and an augmented foot-sole force formed by stacking a ground reaction force on a foot-sole of each supporting leg respectively, q_{g} is a generalized joint space position, \dot{q} is a generalized joint space velocity, and \ddot{q} is a generalized joint space acceleration. Expressions for a matrix and a vector of the impact-aware constraint are:

$${C}_{6 , l} = [ - δ t ( 1 + {c}_{r} ) {Λ}_{c , l} ( {q}_{g}^{fb} ) {P}_{n} {J}_{c , l} ( {q}_{g}^{fb} ) {0}_{3 \times {n}_{F}} ] ∈ {ℛ}^{3 \times {n}_{χ}} , l {b}_{6} = {ι}_{c , l , min} + ( 1 + {c}_{r} ) {Λ}_{c , l} ( {q}_{g}^{fb} ) {P}_{n} ( {J}_{c , l} ( {q}_{g}^{fb} ] {\dot{q}}^{fb} + δ t {\dot{J}}_{c , l} ( {q}_{g}^{fb} ) {\dot{q}}^{fb} ) ∈ {ℛ}^{3} , u {b}_{6} = {ι}_{c , l , max} + ( 1 + {c}_{r} ) {Λ}_{c , l} ( {q}_{g}^{fb} ) {P}_{n} ( {J}_{c , l} ( {q}_{g}^{fb} ) {\dot{q}}^{fb} + δ t {\dot{J}}_{c , l} ( {q}_{g}^{fb} ) {\dot{q}}^{fb} ) ∈ {ℛ}^{3} ,$$

where l_{c,l,min}, l_{c,l,max}∈ [symbol] are an artificially specified lower limit of an allowable collision impulse and an artificially specified upper limit of the allowable collision impulse respectively, and δt represents a time interval between a current moment and the next moment.

An embodiment in a second aspect of the present disclosure provides a planning and control apparatus for a legged robot. The apparatus includes: an obtaining module configured to obtain a movement instruction and a movement state of the legged robot; a generation module configured to generate, based on the movement instruction and the movement state, a reference state sequence of the legged robot and a swing parameter of each leg at a next moment; a planning module configured to determine, based on the movement state and the swing parameter of each leg at the next moment, a foot-end reference state of each leg, and plan, based on a foot-end dynamic model and a discrete collision model, an impact-aware swing leg trajectory for a leg that starts to swing at the next moment, to enable an influence caused by an early collision to be within a target constraint range; and a control module configured to perform, based on the movement state, the reference state sequence, and the foot-end reference state, whole-body control on the legged robot, and perform, based on a whole-body dynamic model and the discrete collision model, impact-aware whole-body control for a leg that is a supporting leg in planning but does not touch the ground, to enable an influence caused by a delayed collision to be within the target constraint range.

In another exemplary embodiment of the present disclosure, a foot-end dynamic model of the planning and control apparatus for the legged robot is:

$${Λ}_{c , l} {\ddot{x}}_{c , l} + {h}_{c , l} = {F}_{j} ,$$

where \ddot{x}∈ [symbol] is a linear acceleration of a foot end of an l-th leg in an inertial system I, Λ_{c,l} is a mass matrix in an operation space, h_{c,l} is a term including a Coriolis force, a centripetal force, and a gravitational force in the operation space, and Fⱼ∈ [symbol] is a foot-end driving force obtained by mapping a torque τⱼ of a driving joint to the operation space. The discrete collision model is:

$$Δ {\dot{x}}_{c , l} = {P}_{n} ( {\dot{x}}_{1}^{+} - {\dot{x}}_{1}^{-} ) = - ( 1 + {c}_{r} ) {P}_{n} {\dot{x}}_{c , l}^{-} ,$$

where Pₙ=nn^{T}∈ [symbol] is a projection operator on a collision normal vector, n∈ [symbol] is a unit normal vector of a collision surface,

$${\dot{x}}_{1}^{+} , {\dot{x}}_{1}^{-} ∈ {ℛ}^{3}$$

are a velocity of a first object before collision and a velocity of the first object after the collision respectively,

$${\dot{x}}_{2}^{+} , {\dot{x}}_{2}^{-} ∈ {ℛ}^{3}$$

are a velocity of a second object before collision and a velocity of the second object after the collision respectively, and cᵣ is a restitution coefficient.

In another exemplary embodiment of the present disclosure, the planning module is further configured to: obtain a pre-defined state variable and a target constraint condition; construct, based on the foot-end dynamic model, the pre-defined state variable, and the target constraint condition, a continuous-time trajectory optimization problem for the leg that starts to swing at a next moment; and discretize the continuous-time trajectory optimization problem to obtain a discrete-time trajectory optimization problem for a foot end of a swing leg, and solve the discrete-time trajectory optimization problem to obtain the impact-aware swing leg trajectory.

In another exemplary embodiment of the present disclosure, the pre-defined state variable of the planning module includes one or more of: an initial state of the foot end of the swing leg, a touchdown state of the foot end of the swing leg, a swing duration, and a desired maximum height of the foot end of the swing leg from the ground. The target constraint condition includes one or more of: a state equation equality constraint, a driving force inequality constraint, a trajectory height inequality constraint, an initial state equality constraint, a terminal state equality constraint, an impact-aware inequality constraint, and a terminal velocity direction inequality constraint.

In another exemplary embodiment of the present disclosure, an objective function of the continuous-time trajectory optimization problem of the planning module is:

$${min}_{x ( t ) , u ( t )} {f}_{TO} = {‖ x ( {t}_{F} ) - [ \begin{matrix}{x}_{c , F}^{ref} \\ {\dot{x}}_{c , F}^{ref}\end{matrix} ] ‖}_{{Q}_{{x}_{F}}} + {\int }_{{t}_{0}}^{{t}_{F}} {‖ u ( τ ) ‖}_{{Q}_{u}} d τ + {\int }_{{t}_{{h}_{1}}}^{{t}_{{h}_{2}}} {‖ {z}_{c} ( τ ) - {z}_{h}^{ref} ‖}_{{Q}_{z}} d τ ,$$

where Qₓ_{_{F}}∈ [symbol] , Qᵤ∈ [symbol] , and Q_{z}∈ [symbol] are weight matrices (mostly diagonal matrices) with different dimensions, ∥a∥_{Q}=a^{T}Qa represents a weighted norm of a vector a under a weight matrix Q,

$${‖ x ( {t}_{F} ) - [ \begin{matrix}{x}_{c , F}^{{}_{ref}} \\ {\dot{x}}_{c , F}^{ref}\end{matrix} ] ‖}_{{Q}_{{x}_{F}}}$$

reflects a task of a touchdown state of the foot end of the swing leg,

$${x}_{c , F}^{ref} ∈ {ℛ}^{3} and {\dot{x}}_{c , F}^{ref} ∈ {ℛ}^{3}$$

are a known terminal position of the foot end of the swing leg and a known linear velocity of the foot end of the swing leg respectively,

$${\int }_{{t}_{0}}^{{t}_{F}} {‖ u ( τ ) ‖}_{{Q}_{u}} d τ$$

is a minimum control variable (i.e., a linear acceleration) in an entire swing process, and t₀=0, t_{F}=T_{sw}, where T_{sw} is a swing duration,

$${\int }_{{t}_{{h}_{1}}}^{{t}_{{h}_{2}}} {‖ {z}_{c} ( τ ) - {z}_{h}^{ref} ‖}_{{Q}_{z}} d τ$$

reflects a task of a maximum height of the swing leg from the ground, tₕ₁ and tₕ₂ are parameters specifying a time period to reach the maximum height, satisfying t₀≤tₕ₁≤tₕ₂≤t_{F}, and z_{c}, is a third component of the state variable, i.e., a component representing a height of the foot end from the ground in the state variable. The discrete-time trajectory optimization problem is:

$${min}_{U} {f}_{c , TO} = {‖ {x}_{N} - {x}_{N}^{ref} ‖}_{{Q}_{{x}_{N}}} + {\sum }_{k = 0}^{N - 1} {‖ {u}_{k} ‖}_{{Q}_{{u}_{k}}} + {\sum }_{k = {k}_{{h}_{1}}}^{{k}_{{h}_{2}}} {‖ {S}_{z} {x}_{k} - {z}_{h}^{ref} ‖}_{{Q}_{{z}_{k}}} , \\ s . t . {\underbrace{[ \begin{matrix}{x}_{c , k + 1} \\ {\dot{x}}_{c , k + 1}\end{matrix} ]}}_{{x}_{k + 1}} = {\underbrace{[ \begin{matrix}{I}_{3 \times 3} & Δ t {I}_{3 \times 3} \\ {0}_{3 \times 3} & {I}_{3 \times 3}\end{matrix} ]}}_{A} {\underbrace{[ \begin{matrix}{x}_{c , k} \\ {\dot{x}}_{c , k}\end{matrix} ]}}_{{x}_{k}} + {\underbrace{[ \begin{matrix}\frac{1}{2} Δ {t}^{2} {I}_{3 \times 3} \\ Δ t {I}_{3 \times 3}\end{matrix} ]}}_{B} {\underbrace{{\ddot{x}}_{c , k}}}_{{u}_{k}} , k = 0 , 1 , . … , N - 1 , \\ {f}_{min} \leq {Λ}_{c} {u}_{k} + {h}_{c} \leq {f}_{max} , k = 0 , 1 , … , N - 1 , \\ {z}_{c , min} \leq {S}_{z} {x}_{k} \leq {z}_{c , max} , k = 1 , 2 , … , N - 1 , \\ {x}_{0} = {x}_{0}^{fb} , \\ {S}_{z , \dot{z}} {x}_{N} = {S}_{z , \dot{z}} {x}_{N}^{ref} , \\ {ι}_{c , min} ⩽ {Λ}_{c} [ - ( 1 + {c}_{r} ) {P}_{n} {S}_{v} {x}_{k} ] ⩽ {ι}_{c , max} , k = {k}_{imp} , {k}_{imp} + 1 , … , N , \\ ( {C}_{{ℓ}_{1}} + \frac{1}{cos {θ}_{c , max}} {D}_{n} ) {S}_{v} {\dot{x}}_{k} \leq {0}_{4 \times 1} , k = {k}_{imp} , {k}_{imp} + 1 , … , N ,$$

where

$$U = {[ {u}_{0}^{T} , {u}_{1}^{T} , … , {u}_{N - 1}^{T} ]}^{T} ∈ {ℛ}^{3 N}$$

is a vector composed of a control variable of each frame, Qₓ_{_{N}}∈ [symbol] , Qᵤ_{ₖ}∈ [symbol] , and Q_{z}_{ₖ}∈ [symbol] are diagonal weight matrices with different dimensions,

$${x}_{0}^{fb} = [ \begin{matrix}{x}_{c , 0}^{fb} \\ {\dot{x}}_{c , 0}^{fb}\end{matrix} ] ∈ {ℛ}^{6}$$

is a feedback of a foot-end state (including a position and a velocity) at a current moment,

$${x}_{N}^{ref} = [ \begin{matrix}{x}_{c , F}^{ref} \\ {\dot{x}}_{c , F}^{ref}\end{matrix} ] ∈ {ℛ}^{6}$$

is a reference terminal foot-end state (including the position and the velocity), S_{ν}=[0_{3×3}I_{3×3}]∈ [symbol] is a selection matrix of a foot-end linear velocity, kₕ_{₁} and kₕ_{₂} are an artificially specified start frame and an artificially specified end frame for maintaining a swing height, satisfying 0≤kₕ_{₁}≤kₕ_{₂}<N, and kᵢₘₚ is a start frame for enabling an impact-aware constraint and a terminal velocity direction constraint, satisfying 0≤kᵢₘₚ≤N.

In another exemplary embodiment of the present disclosure, an optimization problem of the whole-body control of the planning and control apparatus for the legged robot is:

$${min}_{χ} {\sum }_{i = 1}^{{n}_{task}} {‖ {W}_{i} ( {A}_{i} χ - {b}_{i} ) ‖}_{2}^{2} , s . t . {lb}_{j} \leq {C}_{j} χ \leq u {b}_{j ,} j = 1 , 2 , … {n}_{constraint} ,$$

where Aᵢ is a task matrix, bᵢ is a task vector, cⱼ is a constraint matrix, lbⱼ and ubⱼ are a lower constraint bound and an upper constraint bound, Wᵢ is a weight matrix, nₜₐₛₖ is a quantity of tasks, and n_{constraint} is a quantity of constraints.

In another exemplary embodiment of the present disclosure, the tasks processed simultaneously by the whole-body control include two or more of: the trunk trajectory tracking task, the foot-end trajectory tracking task, the foot-sole force tracking task, the task of minimizing variation of a joint torque, and the task of minimizing variation of a foot-sole force. The constraints processed simultaneously by the impact-aware whole-body control include two or more of: the floating-base dynamic equality constraint, the foot-sole force inequality constraint, the joint output torque saturation inequality constraint, the joint rotational speed saturation inequality constraint, the joint output power saturation inequality constraint, and the impact-aware constraint.

In another exemplary embodiment of the present disclosure, the performing, based on the movement state, the reference state sequence, and the foot-end reference state, whole-body control on the legged robot includes: if the leg is the swing leg in planning, setting the foot-end trajectory tracking task as tracking the impact-aware swing leg trajectory, setting the target foot-sole force of the foot-sole force tracking task as the predetermined value, setting the foot-sole force constraint in the foot-sole force inequality constraint as the predetermined value, and disabling the impact-aware constraint; if the leg is the supporting leg in planning and touches the ground, setting the target linear acceleration of the foot-end trajectory tracking task as the predetermined value, setting the target foot-sole force of the foot-sole force tracking task as the foot-sole force provided by the MPC or another module, setting the foot-sole force constraint as the friction cone constraint, and disabling the impact-aware constraint; and if the leg is the supporting leg in planning but does not touch the ground, setting the target of the foot-end trajectory tracking task as tracking the velocity pointing to the collision surface, setting the target foot-sole force of the foot-sole force tracking task as the predetermined value, setting the foot-sole force constraint as the predetermined value, and enabling the impact-aware constraint.

In another exemplary embodiment of the present disclosure, the whole-body dynamic model of the planning and control apparatus for the legged robot is:

$$M ( {q}_{g} ) \ddot{q} + h ( {q}_{g} , \dot{q} ) = [ \begin{matrix}{0}_{6 \times 1} \\ {τ}_{j}\end{matrix} ] + {J}_{c}^{T} ( {q}_{g} ) {F}_{c} ,$$

where M(q_{g})∈ [symbol] is a generalized mass matrix, h(q_{g},\dot{q})∈ [symbol] is a term including a Coriolis force, a centripetal force, and a gravitational force, τⱼ∈ [symbol] represents an output torque of a driving joint, 0_{n×m} represents a zero matrix with a size of n×m,

$${J}_{c}^{T} ( {q}_{g} )$$

and F_{c} are an augmented Jacobian matrix formed by stacking a contact Jacobian matrix of each supporting leg and an augmented foot-sole force formed by stacking a ground reaction force on a foot-sole of each supporting leg respectively, q_{g} is a generalized joint space position, \dot{q} is a generalized joint space velocity, and \ddot{q} is a generalized joint space acceleration. Expressions for the matrix and the vector of the impact-aware constraint are:

$${C}_{6 , l} = [ - δ t ( 1 + {c}_{r} ) {Λ}_{c , l} ( {q}_{g}^{fb} ) {P}_{n} {J}_{c , l} ( {q}_{g}^{fb} ) {0}_{3 \times {n}_{F}} ] ∈ {ℛ}^{3 \times {n}_{χ}} , l {b}_{6} = {ι}_{c , l , min} + ( 1 + {c}_{r} ) {Λ}_{c , l} ( {q}_{g}^{fb} ) {P}_{n} ( {J}_{c , l} ( {q}_{g}^{fb} ) {\dot{q}}^{fb} + δ t {\dot{J}}_{c , l} ( {q}_{g}^{fb} ) {\dot{q}}^{fb} ) ∈ {ℛ}^{3} , u {b}_{6} = {ι}_{c , l , ma x} + ( 1 + {c}_{r} ) {Λ}_{c , l} ( {q}_{g}^{fb} ) {P}_{n} ( {J}_{c , l} ( {q}_{g}^{fb} ) {\dot{q}}^{fb} + δ t {\dot{J}}_{c , l} ( {q}_{g}^{fb} ) {\dot{q}}^{fb} ) ∈ {ℛ}^{3} ,$$

where l_{c,l,min}, l_{c,l,max}∈ [symbol] are the artificially specified lower limit of the allowable collision impulse and the artificially specified upper limit of the allowable collision impulse respectively, and δt represents the time interval between the current moment and the next moment.

An embodiment in a third aspect of the present disclosure provides a legged robot. The legged robot includes: a memory; a processor; and a computer program stored in the memory and executable on the processor. The processor is configured to execute the program to implement the planning and control method for the legged robot according to the above embodiments.

An embodiment in a fourth aspect of the present disclosure provides a computer-readable storage medium. The computer-readable storage medium has a computer program stored thereon. The program is configured to, when executed by a processor, implement the planning and control method for the legged robot according to the above embodiments.

Therefore, the present disclosure may at least provide the following advantageous effects. Embodiments of the present disclosure can perform simplification on a foot-end dynamic model and perform trajectory optimization on a discrete collision model. For an issue of an early collision, planning is performed during swinging to enable an influence caused by the early collision to be within the target constraint range. Also, the whole-body control can be performed on the legged robot based on the whole-body dynamic model and the discrete collision model. For an issue of the delayed collision, processing is performed at a control stage to enable an influence caused by the delayed collision to be within the target constraint range. By concurrently addressing the early collision and the delayed collision, the embodiments of the present disclosure can mitigate an impact force generated at an instant of collision between the foot sole and the ground, which can further reduce an influence of the collision. Therefore, stability of the movement state of the robot can be enhanced, improving a hardware service life of the robot.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a flowchart illustrating a planning and control method for a legged robot according to an embodiment of the present disclosure.

FIG. 2 is a schematic diagram of a gait control system for an impact-aware quadruped robot according to an embodiment of the present disclosure.

FIG. 3 is a schematic diagram of a decision tree for impact-aware whole-body control according to an embodiment of the present disclosure.

FIG. 4 is an exemplary diagram of a planning and control apparatus for a legged robot according to an embodiment of the present disclosure.

FIG. 5 is a schematic structural diagram of a legged robot according to an embodiment of the present disclosure.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

In recent years, the field of a legged robot has developed rapidly. An increasing number of mature and stable methods are applied to movement planning and control for the legged robot. The legged robot from many research institutions is no longer confined to static walking but is evolving towards faster, more agile, more robust, safer, and more multifunctional robots. When the legged robot performs a highly dynamic movement, some problems that may be ignored under low-dynamic movement conditions become non-negligible, such as a collision problem between the foot sole and the ground when the legged robot runs at a high speed. Movement of the legged robot relies on continuous switching of a supporting leg. Each step of walking requires contact between the foot sole and the ground, which is an intentional collision with an environment and is also a common collision problem when the legged robot interacts with the environment. Improper control strategies may cause a violent collision between the foot sole and the ground, affecting a subsequent movement state of the robot, causing the robot to lose balance and fall, and even potentially resulting in a reduced hardware service life or hardware damage.

In the related art, solutions to the collision problem for the legged robot can be provided from two aspects: hardware and a control algorithm.

In terms of the hardware, a foot pad with a certain degree of flexibility may be mount at a foot sole of the robot. Alternatively, a buffer device such as a spring-damper may be mounted at a driving joint of the robot. Alternatively, a VIA or a VSA may be adopted. The VIA and the VSA can provide a desired passive mechanical impedance, achieving an effect of changing a joint impedance at a mechanical level, allowing a buffering effect to be adjusted as desired. A practice of mounting the buffer devices for the robot is commonly referred to as a passive compliance method.

In terms of the control algorithm, to minimize a negative influence of a collision between the foot sole and the ground on the robot's state during walking of the legged robot, a contact velocity between the foot sole and the ground can be planned to approach zero in movement planning. When a small or lightweight legged robot walks slowly on a flat terrain, performance of a controller may usually ensure that an actual movement trajectory of a swing leg is substantially consistent with a planned trajectory. Therefore, this solution works well. When a terrain is uneven, a visual sensor such as a camera or a laser radar may be used to estimate the terrain. A foot movement trajectory, where the contact velocity between the foot sole and the ground approaches zero, may be planned based on the estimated terrain, avoiding a collision impact caused by premature ground contact or delayed ground contact of the foot sole.

However, the methods in the related art have certain limitations.

In terms of the hardware, the passive compliance method can reduce an effect of the collision to some extent, which can also bring some problems. Firstly, introduction of these passive flexible materials may affect a response frequency of a robot system. If the control algorithm does not take this effect into account, unstable vibrations during movement of the robot may easily occur. On the other hand, a buffering effect of the passive compliance method is limited. When a material of the buffer device is determined, stiffness, damping, and inertia characteristics of the material are also determined, and thus the buffering effect cannot be adjusted as desired. When using the VIA method or the VSA method, two motors may be used. One motor is configured to independently control mechanical stiffness of a joint, while another motor is configured to generate a torque, which may result in an overly complex overall structure with a large volume and a large weight, making it difficult to apply such actuators to the legged robot that needs to perform the highly dynamic movement.

In terms of the control algorithm, when the legged robot performs a highly dynamic movement such as a high-speed running, there may be a significant error between the actual movement trajectory of the swing leg and the planned trajectory of the swing leg, causing the premature ground contact of the foot sole or the delayed ground contact of the foot sole. In an exemplary embodiment, in the case of the delayed ground contact, when the foot sole has not yet landed but is required by the planning to support a torso, this leg may rapidly step onto the ground, causing a violent collision and generating an enormous foot-sole impact force at an instant of the collision. For a heavy-duty legged robot, an impact force caused by such collisions is often even greater. When the legged robot runs at the high speed, a violent impact may cause zero drift in the joint, and a long-term frequent collision of the foot-sole may accelerate hardware aging.

In summary, control strategies in the related art consider the impact force during the collision as a disturbance, focusing an emphasis on balance control of the robot after the collision, while neglecting an effect of such frequent, intentional collisions on a hardware service life of the robot.

For the problems mentioned in the above background technology, the present disclosure provides a planning and control method for a legged robot. The planning and control method for the legged robot, the planning and control apparatus for the legged robot, the robot, and the storage medium according to the embodiments of the present disclosure are described below with reference to the accompanying drawings.

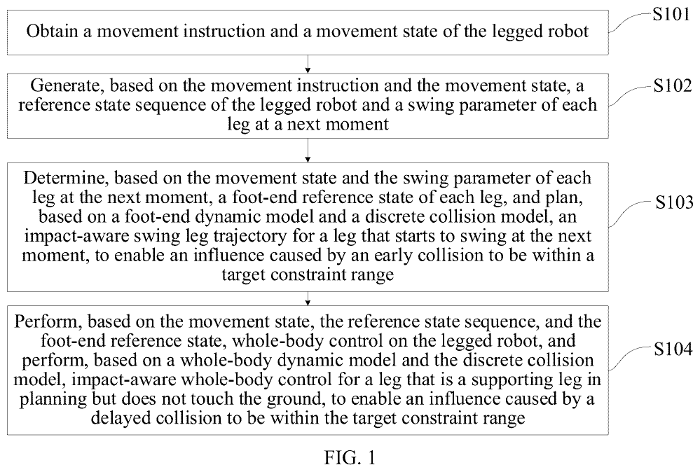

In an exemplary embodiment of the present disclosure, FIG. 1 is a schematic flowchart illustrating a planning and control method for a legged robot according to an embodiment of the present disclosure. As illustrated in FIG. 1, the planning and control method for the legged robot includes operations at blocks.

At block S101, a movement instruction and a movement state of the legged robot are obtained.

The movement instruction may include a movement velocity instruction and a movement direction instruction inputted by a user, etc. The movement state may include a robot trunk state, a foot-end state of each leg, and a touchdown state of each leg, etc.

It should be understood that embodiments of the present disclosure may obtain the movement instruction and the movement state of the legged robot in at least one way. An actuator of the legged robot in the embodiments of the present disclosure is a force-controllable motor, which is equipped with a sensor including an Inertial Measurement Unit (IMU), a motor angle encoder, a motor torque sensor, etc. The following embodiments are elaborated based on this.

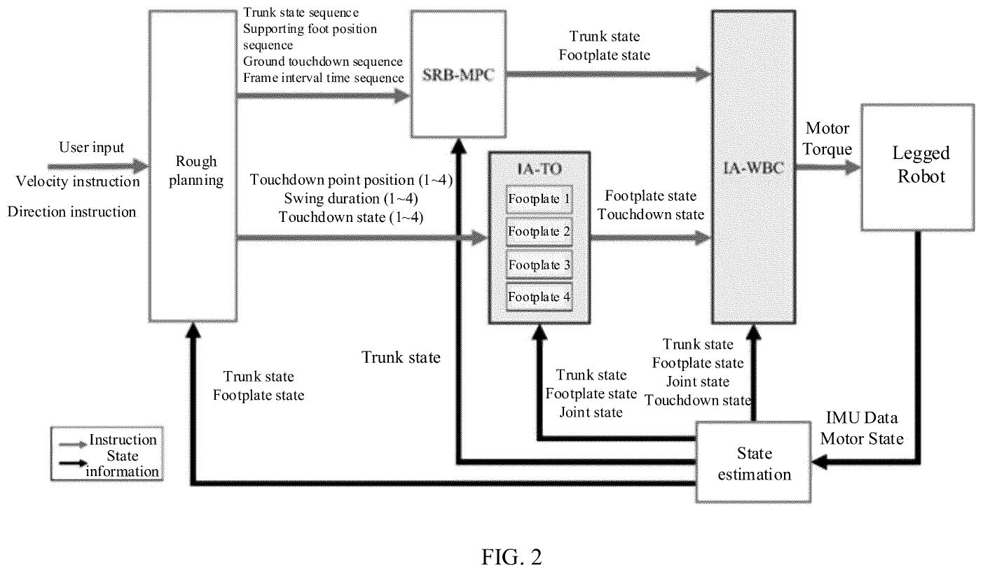

For example, FIG. 2 is a block diagram of a gait control system for an impact-aware quadruped robot according to an embodiment of the present disclosure. The block diagram is applicable to both simulation and actual robots. An entire control framework mainly consists of 5 modules: a State Estimator module, a Rough Planning module, a Single Rigid Body Model Predictive Control (SRB-MPC) module, an Impact-aware Trajectory Optimization (IA-TO) module, and an Impact-aware Whole-body Control (IA-WBC) module. This system operates at a high frequency (e.g., 500 Hz, 1 kHz, etc). The IA-WBC operates at a same frequency. The SRB-MPC operates at around 40 Hz. An optimization problem in the IA-TO is calculated only once each time a leg needs to start swinging. In the following embodiments, this system as an example is described.

In an exemplary embodiment of the present disclosure, as illustrated in FIG. 2, the embodiments of the present disclosure may estimate a trunk state of the legged robot based on read IMU data and motor state information. The IMU data may include a three-dimensional Euler angle, a three-dimensional angular velocity, and a three-dimensional linear acceleration, etc. The motor state information may include a motor rotation angle, a rotational speed, and a feedback torque, etc. The trunk state of the legged robot may include a point position of a trunk, an attitude unit quaternion, a linear velocity, and an angular velocity, etc. The foot-end state of each leg may include the point position and the linear velocity. The embodiments of the present disclosure may use an Extended Kalman Filter (EKF) to estimate the trunk state. The present disclosure is not limited in this regard.

In the embodiments of the present disclosure, state estimation transfers corresponding information according to different needs. As illustrated in FIG. 2, for the SRB-MPC, only the trunk state is transferred. For the IA-TO, the trunk state, the foot-end state of each leg, and the joint state are transferred. For the IA-WBC, the trunk state, the foot-end state of each leg, the joint state, and a touchdown state of each leg are transferred. For the Rough Planning module, the trunk state and the foot-end state of each leg may be transferred. These transferring processes may be described in detail in the following embodiments, and thus details thereof will be omitted here.

At block S102, a reference state sequence of the legged robot and a swing parameter of each leg at a next moment are generated based on the movement instruction and the movement state.

The reference state sequence may be a series of reference variables from a current moment to a future time period. The reference state sequence may include a trunk reference state sequence, a reference position sequence of a foot end of the supporting leg, a reference contact state sequence, and an MPC reference frame interval sequence, etc. The swing parameter may include an initial state of a foot end of the swing leg (an initial position and a linear velocity), the touchdown state (a touchdown point position and a linear velocity), a swing duration, and the desired maximum height of the foot end of the swing leg from the ground, etc.

It should be understood that the embodiments of the present disclosure may utilize the obtained movement instruction and the obtained movement state to generate the reference state sequence of the legged robot and the swing parameter of each leg at the next moment. The embodiments of the present disclosure may perform generation on the reference state sequence and the swing parameter at the next moment in at least one way, such as utilizing the obtained information for movement planning.

In an exemplary embodiment of the present disclosure, as illustrated in FIG. 2, the Rough Planning module may perform a rough movement planning on the quadruped robot based on feedback information from the state estimation and the movement velocity instruction (including a forward/backward walking velocity, a left and right lateral translational velocity) and the movement direction instruction (i.e., a yaw angular velocity) inputted by the user (such as inputted via a remote controller). The Rough Planning module needs to provide the reference state sequence for the SRB-MPC. A quantity of the reference state sequences is the same as a predicted quantity of frames of the SRB-MPC. The Rough Planning module also needs to provide a touchdown point position for a next swing of each leg, a swing duration, and the current reference contact state for the IA-TO.

At block S103, a foot-end reference state of each leg is determined based on the movement state and the swing parameter of each leg at the next moment. Based on a foot-end dynamic model and a discrete collision model, an impact-aware swing leg trajectory is planned for a leg that starts to swing at the next moment, to enable an influence caused by an early collision to be within a target constraint range.

It should be understood that the embodiments of the present disclosure may determine the foot-end reference state of each leg based on the obtained movement state and the swing parameter of each leg of the legged robot at the next moment. When there is the leg starts to swing at the next moment, the impact-aware swing leg trajectory is planned using the foot-end dynamic model and the discrete collision model, to enable the influence caused by the early collision during movement of the swing leg to be within the target constraint range.

It should be noted that factors such as slight ground unevenness, state estimation errors, and control errors may cause the foot-end of the swing leg of the legged robot to contact with the ground before the planned touchdown time, resulting in an “early collision”. This unexpected early contact often brings unexpected collision impacts. This issue may actually be addressed during planning by planning an impact-aware food-end movement trajectory of the swing leg, causing that even if the early collision occurs, the impact force of the collision is within an expected range. Therefore, the embodiments of the present disclosure may formulate a trajectory optimization problem applicable to the swing leg of the legged robot. The employed robot dynamic model is a linearized dynamic model of the foot end of the swing leg in the operation space. The discrete collision model is a discrete collision dynamic model. In the trajectory optimization problem, a prediction time window depends on a planned foot-end swing duration, i.e., a pre-specified foot-end swing duration. To enable online trajectory optimization on the robot's computer, a corresponding optimization problem is designed as an easily solvable Quadratic Programming (QP) problem.

In an exemplary embodiment of the present disclosure, as illustrated in FIG. 2, the Rough Planning module may be configured to provide the IA-TO with the touchdown point position for the next swing of each leg, the swing duration, and the current reference contact state. The IA-TO module may be configured to receive feedback information from the state estimation and reference information from the Rough Planning, generate an appropriate reference state (including a reference point position and a linear velocity) for the foot end of each leg. The SRB-MPC module may be configured to solve an optimization problem in model predictive control based on the reference information from the Rough Planning, obtain an optimal trunk reference state and an optimal reference foot-sole force, which are directly transferred to the IA-WBC. The SRB-MPC may be configured to solve the optimization problem approximately every frame. When the optimization problem has no need to be solved, an output of the SRB-MPC is not updated, i.e., output data is zero-order held.

For the supporting leg, a reference state thereof is to remain stationary on the ground. For the leg that starts to swing, the impact-aware trajectory optimization problem is solved. For a leg already in swing, an optimal solution for the trajectory optimization is interpolated to obtain a reference state at a current moment. The IA-TO module is configured to solve the trajectory optimization only once before a leg needs to start swinging, requiring minimal computation at other times. The IA-TO module ultimately may transfer the reference state of the foot end of each leg, along with the reference contact state provided by the Rough Planning, to the IA-WBC.

In the embodiments of the present disclosure, the planning, based on the foot-end dynamic model and the discrete collision model, the impact-aware swing leg trajectory includes: obtaining a pre-defined state variable and a target constraint condition; constructing, based on the foot-end dynamic model, the pre-defined state variable, and the target constraint condition, a continuous-time trajectory optimization problem for the leg that starts to swing at a next moment; and discretizing the continuous-time trajectory optimization problem to obtain a discrete-time trajectory optimization problem for a foot end of a swing leg, and solving the discrete-time trajectory optimization problem to obtain the impact-aware swing leg trajectory.

The pre-defined state variable may include: an initial state of the foot end of the swing leg, including an initial point position and the linear velocity; a touchdown state of the foot end of the swing leg, including the touchdown point position and the linear velocity; a swing duration T_{sw}∈ [symbol] ; and a desired maximum height

$${z}_{h}^{ref} ∈ ℛ$$

of the foot end of the swing leg from the ground.

The pre-specified state variable in the embodiments of the present disclosure includes one or more of: an initial state of the foot end of the swing leg, a touchdown state of the foot end of the swing leg, a swing duration, and a desired maximum height of the foot end of the swing leg from the ground. The target constraint condition includes one or more of: a state equation equality constraint, a driving force inequality constraint, a trajectory height inequality constraint, an initial state equality constraint, a terminal state equality constraint, an impact-aware inequality constraint, and a terminal velocity direction inequality constraint.

It should be understood that before each leg starts to swing, a trajectory optimization problem needs to be solved to obtain an optimal foot swing trajectory. Considering a limited computing power on an actual robot, trajectory optimization problem for the same leg is not solved repeatedly during swinging of the foot end. Since an expression of the trajectory optimization problem for each leg is essentially identical, for the sake of simplicity in expression, all subscripts l used to indicate a leg index are omitted where no ambiguity exists in the embodiments of the disclosure.

In an exemplary embodiment of the present disclosure, the linear acceleration of the foot end of the swing leg may be used as a control variable, i.e., u=\ddot{x}_{c}∈ [symbol] . A state variable is selected as a point position and a linear velocity of the foot end, i.e.,

$$x = {[ \begin{matrix}{x}_{c}^{T} & {\dot{x}}_{c}^{T}\end{matrix} ]}^{T} ∈ {ℛ}^{6} .$$

Based on this, an objective function, a constraint condition, and a discrete-time trajectory optimization problem of the embodiments of the present disclosure are described below.

### I. Objective Function

In the embodiments of the present disclosure, the foot-end dynamic model is:

$${Λ}_{c , l} {\ddot{x}}_{c , l} + {h}_{c , l} = {F}_{j} ,$$

where \ddot{x}_{c,l}∈ [symbol] is a linear acceleration of a foot end of an l-th leg in an inertial system I, Λ_{c,l} is a mass matrix in an operation space, h_{c,l} is a term including a Coriolis force, a centripetal force, and a gravitational force in the operation space, and Fⱼ∈ [symbol] is a foot-end driving force obtained by mapping a torque τⱼ of a driving joint to the operation space. A process for obtaining the foot-end dynamic model in the embodiments of the present disclosure is as follows.

In the embodiments of the present disclosure, a point position, a linear velocity, and the linear acceleration of the foot end of the l-th leg in the inertial system I may be denoted as x_{c,l}, \dot{x}_{c,l}, \ddot{x}_{c,l}∈ [symbol] , respectively. Then, a dynamic equation for the foot end in the operation space is:

$${Λ}_{c , l} ( {q}_{g} ) {\ddot{x}}_{c , l} + {h}_{c , l} ( {q}_{g} , \dot{q} ) = {F}_{j} + {F}_{c , l}$$

where Fⱼ, F_{c,l}∈ [symbol] are the foot-end driving force obtained by mapping the torque τⱼ of the driving joint to the operation space and a ground reaction force on the foot end (the latter exists only during contact with the ground) respectively, Λ_{c,l}(q_{g}) is a mass matrix in the operation space, and h_{c,l}(q_{g},\dot{q}) is a term including the Coriolis force, the centripetal force, and the gravitational force in the operation space.

Considering that even if the legged robot performs a dynamic movement, the swing leg of the legged robot mostly remains within certain ranges under a trunk. The embodiments of the present disclosure may assume that a range of leg configuration variation in a single swing phase is not excessively large. Therefore, Λ_{c,l}(q_{g}) may be approximately considered as configuration-independent and treated as a constant matrix. Experimental evidence shows that a nonlinear term h_{c,l}(q_{g},\dot{q}) also varies insignificantly during leg swing and may be approximately as a constant vector.

Consequently, the simplified foot-end dynamic model is obtained as:

$${Λ}_{c , l} {\ddot{x}}_{c , l} + {h}_{c , l} = {F}_{j} ,$$

treating a foot sole of the l-th leg as a first object and the ground as a second object, and considering that a ground mass is much larger than a robot mass and that a ground velocity remains zero before the collision and after the collision, the discrete collision model of the embodiments of the present disclosure is further derived as:

$$Δ {\dot{x}}_{c , l} = {P}_{n} ( {\dot{x}}_{1}^{+} - {\dot{x}}_{1}^{-} ) = - ( 1 + {c}_{r} ) {P}_{n} {\dot{x}}_{c , l}^{-} ,$$

where Pₙ=nn^{T}∈ [symbol] is a projection operator on a collision normal vector, n∈ [symbol] is a unit normal vector of a collision surface,

$${\dot{x}}_{1}^{+} , {\dot{x}}_{1}^{-} ∈ {ℛ}^{3}$$

are a velocity of a first object before collision and a velocity of the first object after the collision respectively,

$${\dot{x}}_{2}^{+} , {\dot{x}}_{2}^{-} ∈ {ℛ}^{3}$$

are a velocity of a second object before collision and a velocity of the second object after the collision respectively, and cᵣ is a restitution coefficient, which is defined as

$${c}_{r} {=}^{def} - \frac{{n}^{T} ( {\dot{x}}_{2}^{+} - {\dot{x}}_{1}^{+} )}{{n}^{T} ( {\dot{x}}_{2}^{-} - {\dot{x}}_{1}^{-} )} .$$

In the embodiments of the present disclosure, an objective function of the continuous-time trajectory optimization problem is:

$${min}_{x ( t ) , u ( t0} {f}_{TO} = {‖ x ( {t}_{F} ) - [ \begin{matrix}{x}_{c , F}^{ref} \\ {\dot{x}}_{c , F}^{ref}\end{matrix} ] ‖}_{{Q}_{{x}_{F}}} + {\int }_{{t}_{0}}^{{t}_{F}} {‖ u ( τ ) ‖}_{{Q}_{u}} d τ + {\int }_{{t}_{{h}_{1}}}^{{t}_{{h}_{2}}} {‖ {z}_{c} ( τ ) - {z}_{h}^{ref} ‖}_{{Q}_{z}} d τ ,$$

where Qₓ_{_{F}}∈ [symbol] , Qᵤ∈ [symbol] , and Q_{z}∈ [symbol] are weight matrices (mostly diagonal matrices) with different dimensions, ∥a∥_{Q}=a^{T}Qa represents a weighted norm of a vector a under a weight matrix Q,

$${‖ x ( {t}_{F} ) - [ \begin{matrix}{x}_{c , F}^{ref} \\ {\dot{x}}_{c , F}^{ref}\end{matrix} ] ‖}_{{Q}_{{x}_{F}}}$$

reflects a task of a touchdown state of the foot end of the swing leg,

$${x}_{c , F}^{ref} ∈ {ℛ}^{3} and {x}_{c , F}^{ref} ∈ {ℛ}^{3}$$

are a known terminal position of the foot end of the swing leg and a known linear velocity of the foot end of the swing leg respectively,

$${\int }_{{t}_{0}}^{{t}_{F}} {‖ u ( τ ) ‖}_{{Q}_{u}} d τ$$

is a minimum control variable (i.e., a linear acceleration) in an entire swing process, and t₀=0, t_{F}=T_{sw}, where T_{sw} is a swing duration,

$${\int }_{{t}_{{h}_{1}}}^{{t}_{{h}_{2}}} {‖ {z}_{c} ( τ ) - {z}_{h}^{ref} ‖}_{{Q}_{z}} d τ$$

reflects a task of a maximum height of the swing leg from the ground, tₕ₁ and tₕ₂ are parameters specifying a time period to reach the maximum height, satisfying t₀≤tₕ₁≤tₕ₂≤t_{F}, and z_{c} is a third component of the state variable, i.e., a component representing a height of the foot end from the ground in the state variable.

### II. Constraints

(1) State Equation Equality Constraint: since the control variable is selected as the linear acceleration of the foot end, the state equation is straightforward. Define:

$${A}_{c} = [ \begin{matrix}{0}_{3 \times 3} & {I}_{3 \times 3} \\ {0}_{3 \times 3} & {0}_{3 \times 3}\end{matrix} ] , {B}_{c} = [ \begin{matrix}{0}_{3 \times 3} \\ {I}_{3 \times 3}\end{matrix} ] ,$$

Then, a state equation of a system can be written as:

$$\frac{d}{dt} x ( t ) = {A}_{c} x ( t ) + {B}_{c} u ( t ) , for t ∈ [ {t}_{0} , {t}_{F} ] .$$

(2) Driving Force Constraint: due to output torque limits of an actual actuator, i.e., an upper limit of an output torque and a lower limit of the output torque, correspondingly the foot-end driving force in the operation space has a lower limit ƒₘᵢₙ∈ [symbol] and an upper limit ƒₘₐₓ∈ [symbol] . Therefore, the driving force constraint can be written as:

$${f}_{min} \leq {S}_{2} x ( t ) {\leq }_{c , max} , for t ∈ [ {t}_{0} , {t}_{F} ] ,$$

(3) Trajectory Height Constraint: to prevent an optimized trajectory from being below the ground or higher than the desired maximum height from the ground, constraints on a trajectory height are needed, i.e.,

$${z}_{c , min} \leq {S}_{2} x ( t ) \leq {z}_{c , max} , for t ∈ [ {t}_{0} , {t}_{F} ] ,$$

where z_{c,min}, z_{c,max}∈ [symbol] are an upper limit and a lower limit of the trajectory height, and S_{z}=[0,0,1,0,0,0]∈ [symbol] is a selection matrix used to select a third component of a state.

(4) Initial State Constraint: the initial state in the trajectory optimization of the foot end of the swing leg is a state just before the foot end leaves the ground. Therefore, the initial state constraint is:

$$x ( {t}_{0} ) = [ \begin{matrix}{x}_{c , 0}^{fb} \\ {\dot{x}}_{c , 0}^{fb}\end{matrix} ] ,$$

where

$${x}_{c , 0}^{fb} , {\dot{x}}_{c , 0}^{fb} ∈ {ℛ}^{3}$$

are a latest feedback point position and a latest linear velocity of the foot end of the swing leg before solving the trajectory optimization problem, respectively.

(5) Terminal State Constraint: although the objective function already incorporates a task of a terminal state, the objective function cannot guarantee that a height of an end of the optimized foot-end trajectory from the ground is zero. That is, the end of the trajectory may be suspended in the air or penetrate the ground. Therefore, a terminal state constraint is needed, i.e.,

$${S}_{z , \dot{z}} x ( {t}_{F} ) = [ \begin{matrix}{z}_{c , F}^{ref} \\ {\dot{z}}_{c , F}^{ref}\end{matrix} ] ,$$

where

$${z}_{c , F}^{ref} ∈ ℛ and {\dot{z}}_{c , F}^{ref} ∈ ℛ$$

are a reference height and a vertical direction reference velocity at the trajectory's end, respectively, and where

$${\dot{z}}_{c , F}^{ref} = 0.$$

S_{z,ż} is a corresponding selection matrix, i.e.,

$${S}_{z , \dot{z}} = [ \begin{matrix}001000 \\ 000001\end{matrix} ] .$$

It should be noted that the terminal state constraint in the embodiments of the present disclosure does not constrain a component of a horizontal direction in the state. This is because, under conditions with many constraints, a desired terminal state in the horizontal direction may be unattainable. Enforcing the terminal state constraint in the horizontal direction may result in an infeasible optimization problem.

(6) Impact-aware Constraint: to ensure sufficient deceleration of the swing leg before touchdown to reach a safe velocity, an impact-aware constraint is considered at an end of the trajectory in the embodiments of the present disclosure. Assuming a collision process starts at a time of t_{c} and ends at a time of t_{c}+δt, both sides of an equation of Λ_{c,l}(q_{g})\ddot{x}_{c,l}+h_{c,l}(q_{g},\dot{q})=Fⱼ+F_{c,l} is integrated, it follows that:

$${\int }_{{t}_{c}}^{{t}_{c} + δ t} {Λ}_{c} ( {q}_{g} ) {\ddot{x}}_{c} + {h}_{c} ( {q}_{c} , \dot{q} ) dt = {\int }_{{t}_{c}}^{{t}_{c} + δ t} {F}_{j} + {F}_{c} dt .$$

Since a configuration of the robot remains almost unchanged before the collision and after the collision, i.e.,

$${q}_{g}^{+} = {q}_{g}^{-} .$$

In addition, a collision process is extremely short, i.e., δt→0. In this case, an impulse from a limited force (such as the gravitational force, the Coriolis force, and the centripetal force) may appear in this limit, leaving only an impulse generated by the collision. Therefore, the above formula becomes

$${Λ}_{c} Δ {\dot{x}}_{c} = {Λ}_{c} ( {\dot{x}}_{c}^{+} - {\dot{x}}_{c}^{-} ) = {ι}_{c}$$

where δt→0, where l_{c}∈ [symbol] represents an impulse exerted by the ground on the foot end. Substituting this expression into a pre-collision model yields the impact-aware constraint:

$${ι}_{c , min} \leq {Λ}_{c} ( - ( 1 + {c}_{r} ) {P}_{n} {\dot{x}}_{c} ( t ) ) \leq {ι}_{c , max} , for t ∈ [ {t}_{imp} , {t}_{F} ] ,$$

where l_{c,min}, l_{c,max}∈ [symbol] are an artificially specified lower limit of an allowable collision impulse and an artificially specified upper limit of the allowable collision impulse respectively, and tᵢₘₚ is an artificially specified duration to activate the impact-aware constraint, satisfying t₀≤tᵢₘₚ≤t_{F}.

It should be understood that a formula of the impact-aware constraint may indicate that if the early collision occurs due to certain reasons during a time period of [tᵢₘₚ, t_{F}] immediately before the foot end of the swing leg touches the ground, an impulse caused by the collision may fall within a constraint range of this equation. Further, this constraint cannot be activated throughout the entire swing process. Otherwise, the entire swing movement may become excessively slow, resulting in a failure in realizing normal running movement.

(7) Terminal Velocity Direction Constraint: if a velocity direction of the foot end of the swing leg is nearly horizontal just before touchdown, then due to errors in controlling a height of the foot end, the foot sole touching the ground prematurely may occur, resulting in the foot end of the swing leg not reaching the planned foot point position, which may potentially affect stability of a center of mass of the robot. Therefore, the embodiments of the present disclosure can design the terminal velocity direction constraint for the foot end, in such a manner that an angle θ_{c} between a velocity \dot{x}_{c}(t) of the foot end of the swing leg before touchdown and a unit normal vector −n (a negative sign indicates a direction pointing inwardly) of the collision surface is within a certain specified range, i.e.:

$$cos {θ}_{c , max} \leq \frac{- {n}^{T} {\dot{x}}_{c} ( t )}{{‖ {\dot{x}}_{c} ( t ) ‖}_{2}} , for t ∈ [ {t}_{imp} , {t}_{F} ] ,$$

where

$${θ}_{c , max} ∈ ( 0 , \frac{π}{2} )$$

is an artificially specified maximum allowable angle. The above nonlinear expression may be linearized through scaling. Based on a relationship between a norm [symbol] and a norm [symbol] of the vector, it follows that:

$$\frac{- {n}^{T} {\dot{x}}_{c} ( t )}{{‖ {\dot{x}}_{c} ( t ) ‖}_{1}} \leq \frac{- {n}^{T} {\dot{x}}_{c} ( t )}{{‖ {\dot{x}}_{c} ( t ) ‖}_{2}} , ∀ {x}_{c} ( t ) \neq {0}_{3 \times 1} and {x}_{c} ( t ) ∈$$

Therefore, the rewritten

$$cos {θ}_{c , max} \leq \frac{- {n}^{T} {\dot{x}}_{c} ( t )}{{‖ {\dot{x}}_{c} ( t ) ‖}_{2}} , for t ∈ [ {t}_{imp} , {t}_{F} ] ,$$

may be obtained. Any solution that satisfies the rewritten formula also satisfies the original formula. Therefore, the rewritten formula may be used as the terminal velocity direction constraint for TO, which can be further written as:

$$\vert {\dot{x}}_{c , x} ( t ) \vert + \vert {\dot{x}}_{c , y} ( t ) \vert + \vert {\dot{x}}_{c , z} ( t ) \vert \leq - \frac{1}{cos {θ}_{c , max}} {n}^{T} {\dot{x}}_{c} ( t ) , for t ∈ [ {t}_{imp} , {t}_{F} ] ,$$

where \dot{x}_{c,x}(t),\dot{x}_{c,y}(t),\dot{x}_{c,z}(t) is respective components of \dot{x}_{c}(t). By traversing all cases within absolute value symbols, the above expression can be further written as eight equivalent inequalities, which are:

$$[ \begin{matrix}1 & 1 & 1 \\ - 1 & 1 & 1 \\ 1 & - 1 & 1 \\ - 1 & - 1 & 1 \\ 1 & 1 & - 1 \\ - 1 & 1 & - 1 \\ 1 & - 1 & - 1 \\ - 1 & - 1 & - 1\end{matrix} ] {\dot{x}}_{c} ( t ) \leq - \frac{1}{cos {θ}_{c , max}} [ \begin{matrix}{n}^{T} \\ {n}^{T} \\ {n}^{T} \\ {n}^{T} \\ {n}^{T} \\ {n}^{T} \\ {n}^{T} \\ {n}^{T}\end{matrix} ] {\dot{x}}_{c} ( t ) , for t ∈ [ {t}_{imp} , {t}_{F} ]$$

However, during a short time period before the swing leg touches the ground, it is usually the case that \dot{x}_{c,z}(t)≤0. The first four rows of the equation are typically redundant. Therefore, the terminal velocity direction constraint can be simplified to:

$$( {C}_{{ℓ}_{1}} + \frac{1}{cos {θ}_{c , max}} {D}_{n} ) {x}_{c} ( t ) \leq {0}_{4 \times 1} , for t ∈ [ {t}_{imp} , {t}_{F} ] , where {C}_{{ℓ}_{1}} = [ \begin{matrix}1 & 1 & - 1 \\ - 1 & 1 & - 1 \\ 1 & - 1 & - 1 \\ - 1 & - 1 & - 1\end{matrix} ] , {D}_{n} = [ \begin{matrix}{n}^{T} \\ {n}^{T} \\ {n}^{T} \\ {n}^{T}\end{matrix} ] .$$

### III. Discrete-Time Trajectory Optimization Problem

It should be understood that, to facilitate the solution of the above continuous-time trajectory optimization problem on a computer, the embodiments of the present disclosure may also perform discretization. In particular, at least one discretization method can be used in the embodiments of the present disclosure. For example, an integral term in the objective function can be replaced by a finite sum, and the state equation constraint can be replaced by a Taylor expansion formula with higher-order terms neglected.

In the embodiments of the present disclosure, assume that a swing process is evenly divided into N segments over time, i.e., there are N frames, with a frame interval of Δt=T_{sw}/N. Let tₖ=t₀+k(t_{F}−t₀)/N, k=1, 2, . . . , N, then we can denote xₖ=x(tₖ) and uₖ=u(tₖ). The entire discrete-time trajectory optimization problem can be formulated as.

$$g$$

$${z}_{c , min} \leq {S}_{z} {x}_{k} \leq {z}_{c , max} , k = 1 , 2 , … , N - 1 ,$$

$${x}_{0} = {x}_{0}^{fb} ,$$

$${S}_{Z , \dot{Z}} {x}_{N} = {S}_{Z , \dot{Z}} {x}_{N}^{ref} ,$$

$${ι}_{c , min} ⩽ {Λ}_{c} [ - ( 1 + {c}_{r} ) {P}_{n} {S}_{v} {x}_{k} ] ⩽ {ι}_{c , max} , k = {k}_{imp} , {k}_{imp} + 1 , … , N ,$$

$$( {C}_{{ℓ}_{1}} + \frac{1}{cos {θ}_{c , max}} {D}_{n} ) {S}_{v} {x}_{k} \leq {0}_{4 \times 1} , k = {k}_{imp} , {k}_{imp} + 1 , … , N ,$$

where

$$U = {[ {u}_{0}^{T} , {u}_{1}^{T} , … , {u}_{N - 1}^{T} ]}^{T} ∈$$

is a vector composed of a control variable of each frame, Qₓ_{_{N}}∈ [symbol] , Qᵤ_{ₖ}∈ [symbol] , and Q_{z}∈ [symbol] are diagonal weight matrices with different dimensions,

$${x}_{0}^{fb} = [ \begin{matrix}{x}_{c , 0}^{fb} \\ {\dot{x}}_{c , 0}^{fb}\end{matrix} ] ∈$$

is a feedback of a foot-end state (including a position and a velocity) at a current moment,

$${x}_{N}^{ref} = [ \begin{matrix}{x}_{c , F}^{ref} \\ {\dot{x}}_{c , F}^{ref}\end{matrix} ] ∈$$

is a reference terminal foot-end state (including the position and the velocity), S_{ν}=[0_{3×3}I_{3×3}]∈ [symbol] is a selection matrix of a foot-end linear velocity, kₕ_{₁} and kₕ_{₂} are an artificially specified start frame and an artificially specified end frame for maintaining a swing height, satisfying 0≤kₕ_{₁}≤kₕ_{₂}<N, and kᵢₘₚ is a start frame for enabling an impact-aware constraint and a terminal velocity direction constraint, satisfying 0≤kᵢₘₚ≤N.

It should be understood that, since trajectory optimization problems in many studies are highly nonlinear and typically belong to non-convex optimization problems, using some professional nonlinear solvers can help find local optimal solutions for the trajectory optimization problems, but cannot guarantee a global optimal solution. In the embodiments of the present disclosure, the trajectory optimization problem is a QP problem, which belongs to a typical convex optimization problem. Therefore, as long as the problem has a non-empty solution set, an optimal solution found by the optimizer is the global optimal solution.

For the objective function of the discrete-time trajectory optimization problem of the foot end of the swing leg described above, some QP solvers can be used for solving the function. For example, in the embodiments of the present disclosure, an open-source library of qpOASES based on C++ can be used, which requires the QP problem to be converted into a standard form:

$${min}_{U} \frac{1}{2} {U}^{T} HU + {g}^{T} U ,$$

$$s . t . l b \leq CU \leq ub .$$

After solving the optimal solution of the above equation, only an optimal control variable U* of N frames is obtained, which is used to determine an optimal position and a velocity trajectory. The above N rows of discrete dynamic equations are written as a linear expression in terms of an initial state and an optimization variable, i.e.,

$$X = {A}_{QP} {x}_{0}^{fb} + {B}_{QP} U ,$$

$$where X = {[ {x}_{0}^{T} , {x}_{1}^{T} , … , {x}_{N}^{T} ]}^{T} ∈ {ℛ}^{6 N} , and {A}_{QP} and {B}_{QP} are$$

$${A}_{QP} = [ \begin{matrix}A \\ {A}^{2} \\ ⋮ \\ {A}^{N}\end{matrix} ] ∈ {ℛ}^{6 N \times 6} and {B}_{QP} = [ \begin{matrix}B & {0}_{6 \times 3} & … & {0}_{6 \times 3} \\ AB & B & … & {0}_{6 \times 3} \\ ⋮ & ⋮ & ⋱ & ⋮ \\ {A}^{N - 1} B & {A}^{N - 2} B & … & B\end{matrix} ] ∈ {ℛ}^{6 N \times 3 N} .$$

Therefore, by substituting U* into the above linear expression, a corresponding optimal position and a corresponding velocity for the N frames are obtained.

Since the subsequent control program may require a corresponding reference trajectory at any moment, in this case it is necessary to convert N discrete points into a continuous curve by an interpolation method. In the embodiments of the present disclosure, at least one method can be used to achieve interpolation. For a maximum computational efficiency, a simplest linear interpolation can be employed in the embodiment of the disclosure.

For example, assume that from the moment when the swing leg leaves the ground, in this case a time of t_{sw}, has elapsed, where t_{sw}∈[0, T_{sw}]. A closest previous frame to this moment is a k-th frame, with the corresponding optimal position being

$${x}_{c , k}^{*} .$$

Using a linear interpolation method, an optimal reference position in this case is:

$${x}_{c}^{*} ( {t}_{sw} ) = {x}_{c , k}^{*} + \frac{{t}_{sw} - k Δ t}{Δ t} {x}_{c , k + 1}^{*} .$$

Similarly, a corresponding optimal reference velocity

$${\dot{x}}_{c}^{*} ( {t}_{sw} )$$

may be obtained.

It should be noted that this interpolation method fails to guarantee that a time integral of the velocity trajectory is a position curve. To achieve this, a higher-order interpolation function may be required. In this case, a trade-off is made by sacrificing some interpolation accuracy to maximize a computational efficiency.

At block S104, whole-body control is performed on the legged robot based on the movement state, the reference state sequence, and the foot-end reference state. Based on a whole-body dynamic model and the discrete collision model, impact-aware whole-body control is performed for a leg that is a supporting leg in planning but does not touch the ground, to enable an influence caused by a delayed collision to be within the target constraint range

It should be understood that, as illustrated in FIG. 2, the embodiments of the present disclosure can solve a Weighted Quadratic Programming (WQP) problem and calculate an optimal joint torque instruction based on feedback information from state estimation and reference information from the SRB-MPC module and the IA-TO module, achieving whole-body control of the legged robot and addressing an issue of the delayed collision.

It should be noted that the term “delayed collision” refers to a situation where, due to certain reasons (e.g., the slight ground unevenness, errors in state estimation, or control inaccuracies), the foot end has not yet made contact with the ground at an originally planned time point, in this case contact between the foot end and the ground necessarily occurs later than the originally planned time point. Without an appropriate control strategy, such unintended delayed collisions can easily result in unintended collision impact. The problem of delayed collision is substantially different from that of early collision, in that the delayed collision occurs outside a planned swing process. Therefore, a distance between the foot sole and the ground (which is expected to be zero) cannot be accurately determined, and also an exact timing of ground contact (which is supposed to occur at a specific moment) becomes uncertain, which may be effectively solved in a control stage. Therefore, based on a core concept of one step predictive control, the embodiments of the present disclosure may use an impact-aware Whole Body Control (WBC) method.

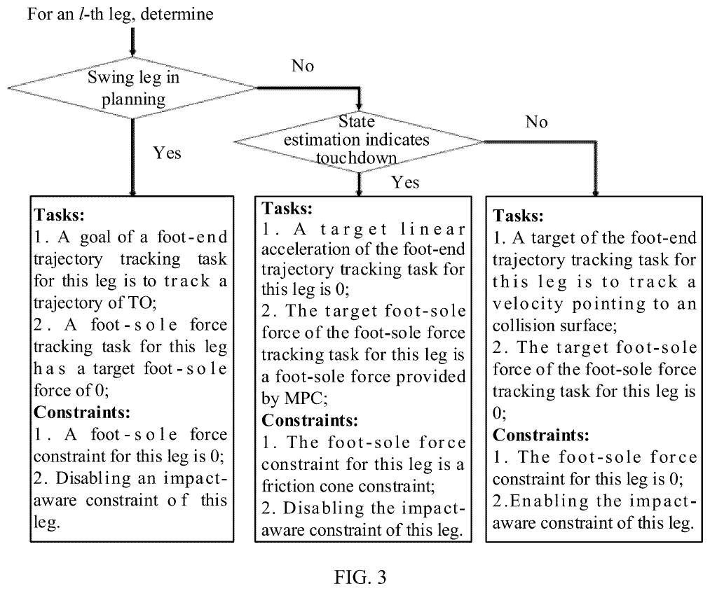

In the following embodiments, the quadruped robot is used as an example to describe the WBC method of the embodiments of the present disclosure. The impact-aware constraint is not always enabled. Depending on different situations, a task objective and constraint setting of whole-body control vary accordingly. Therefore, the embodiments of the present disclosure may be expressed using a decision tree as illustrated in FIG. 3. The impact-aware whole-body control in the embodiment of the present disclosure is detailed as follows.

### I. Whole-Body Control Based on Weighted Quadratic Programming

It should be understood that, to enable the whole-body control to properly handle an inequality constraint such as the impact-aware constraint, an optimization-based approach is selected for implementation of the whole-body control. Also, considering limited computational resources available on the actual robot and thus there are multiple programs (e.g., communication, control algorithms) that need to operate simultaneously, the embodiments of the present disclosure may adopt a whole-body control method implemented based on the WQP.

In the embodiments of the present disclosure, an optimization problem of the whole-body control is:

$${min}_{χ} {\sum }_{i = 1}^{{n}_{task}} {‖ {W}_{i} ( {A}_{i} χ - {b}_{i} ) ‖}_{2}^{2} ,$$

$$s . t . l {b}_{j} \leq {C}_{j} χ \leq {ub}_{j} , j = 1 , 2 , … , {n}_{constraint} ,$$

where Aᵢ is a task matrix, bᵢ is a task vector, cⱼ is a constraint matrix, lbⱼ and ubⱼ are a lower constraint bound and an upper constraint bound, Wᵢ is a weight matrix, nₜₐₛₖ is a quantity of tasks, and n_{constraint} is a quantity of constraints.

It should be understood that, in the WQP, all tasks that need to be completed are represented in the objective function in a form of Aᵢχ−bᵢ, and a relative priority of tasks is adjusted by the weight matrix Wᵢ. All constraints are expressed in a form of lbⱼ≤cⱼχ≤ubⱼ. The equality constraint may be achieved by setting lbⱼ=ubⱼ. In the embodiments of the present disclosure, optimization variables of the WBC are selected as a generalized joint space acceleration of \ddot{q} and an augmented foot-sole force of F_{c} formed by stacking forces acting on foot ends of four feet, i.e.,

$$χ = {[ {\ddot{q}}^{T} , {F}_{c}^{T} ]}^{T} ∈ {ℛ}^{{n}_{χ}} ,$$

where

$${n}_{χ} = {n}_{q} + {n}_{F} .$$

When the quadruped robot is in a stationary standing state, the whole-body dynamic model of the legged robot in the embodiments of the present disclosure is:

$$M ( {q}_{g} ) \ddot{q} + h ( {q}_{g} , \dot{q} ) = [ \begin{matrix}{0}_{6 \times 1} \\ {τ}_{j}\end{matrix} ] + {J}_{c}^{T} ( {q}_{g} ) {F}_{c} ,$$

where M(q_{q})∈ [symbol] is a generalized mass matrix, h(q_{g},\dot{q})∈ [symbol] is a term including a Coriolis force, a centripetal force, and a gravitational force, τⱼ∈ [symbol] represents an output torque of a driving joint, 0_{n×m} represents a zero matrix with a size of n×m,

$${J}_{c}^{T} ( {q}_{g} )$$

and F_{c} are an augmented Jacobian matrix formed by stacking a contact Jacobian matrix of each supporting leg and an augmented foot-sole force formed by stacking a ground reaction force on a foot sole of each supporting leg, respectively, q_{g} is a generalized joint space position, \dot{q} is a generalized joint space velocity, and \ddot{q} is a generalized joint space acceleration.

By solving the above QP problem, the optimal solution χ* may be obtained. Combining with a complete dynamic equation, the optimal joint torque instruction

$${τ}_{j}^{cmd}$$

can be easily calculated as:

$${τ}_{j}^{cmd} = ( {S}_{j} M ( {q}_{g}^{fb} ) - {S}_{j} {J}_{c}^{T} ( {q}_{g}^{fb} ) ) {χ}^{*} + {S}_{j} h ( {q}_{g}^{fb} , {\dot{q}}^{fb} ) ,$$

where Sⱼ=[0ₙ_{ⱼ}_{×6}Iₙ_{ⱼ}_{×n}_{ⱼ}]∈ [symbol] is a selection matrix of the driving joint, and

$${q}_{g}^{fb}$$

and \dot{q}^{fb} are the generalized joint space position and a velocity feedback provided by the state estimation respectively.

### II. Task Setting

In the embodiments of the present disclosure, tasks processed simultaneously by the whole-body control include two or more of: a trunk trajectory tracking task, a foot-end trajectory tracking task, a foot-sole force tracking task, a task of minimizing variation of a joint torque, and a task of minimizing variation of a foot-sole force. Constraints processed simultaneously by the impact-aware whole-body control include two or more of: a floating-base dynamic equality constraint, a foot-sole force inequality constraint, a joint output torque saturation inequality constraint, a joint rotational speed saturation inequality constraint, a joint output power saturation inequality constraint, and an impact-aware constraint.

In an exemplary embodiment of the present disclosure, (1) a trunk tracking task: the trunk trajectory tracking task is a basic task allowing for movement of the quadruped robot, which is indispensable. In the embodiments of the present disclosure, a trunk reference movement trajectory provided by the Model Predictive Control (MPC) may be used. The trajectory includes an optimal reference point position

$${r}_{b}^{MPC}$$

of a trunk, an optimal reference linear velocity

$${\dot{r}}_{b}^{MPC} ,$$

and an optimal Z—Y—X Euler angle

$${Θ}_{b}^{M P C}$$

in the inertial system I, and an optimal reference angular velocity

$${}^{B} {ω}_{b}^{MPC}$$

of the trunk under a floating-base system B.

In the WBC, PD control is performed based on an optimal reference trajectory provided by the MPC and a feedback state provided by the state estimation to obtain a linear acceleration instruction

$${\ddot{r}}_{b}^{cmd}$$

of the trunk in the inertial system I and an angular acceleration instruction

$${}^{B} {\dot{ω}}_{b}^{cmd}$$

under the floating-base system B. Then, corresponding tasks are designed to complete these instructions. The PD control is:

$${\ddot{r}}_{b}^{cmd} = {K}_{p , {r}_{b}} ( {r}_{b}^{MPC} - {r}_{b}^{tb} ) + {K}_{d , {r}_{b}} ( {\dot{r}}_{b}^{MPC} - {\dot{r}}_{b}^{fb} ) ,$$

$${}^{B} {\dot{ω}}_{b}^{cmd} = {K}_{p , {ω}_{b}} {}^{B} {e}_{θ} + {K}_{d , {ω}_{b}} ( {}^{B} {ω}_{b}^{MPC} - {}^{B} {ω}_{b}^{fb} ) ,$$

where K_{p,r}_{_{b}}, K_{d,r}_{_{b}}, K_{p,ω}_{_{b}}, K_{d,ω}_{_{b}}∈ [symbol] are PD gain coefficient matrices, all of which are diagonal matrices, and Bₑ_{_{θ}}∈ [symbol] is an axis angle representing a pose error calculated based on a reference Z—Y—X Euler angle

$${Θ}_{b}^{MPC}$$

and a feedback Z—Y—X Euler angle

$${Θ}_{b}^{fb} .$$

Since the first 6 rows of \ddot{q} correspond to a linear acceleration and an angular acceleration of a floating base, a corresponding matrix and a corresponding vector for the trunk trajectory tracking task are written as:

$${A}_{1} = [ \begin{matrix}{I}_{6 \times 6} & {0}_{6 \times ( {n}_{j} + {n}_{F} )}\end{matrix} ] ∈ and {b}_{1} = [ \begin{matrix}{\ddot{r}}_{b}^{cmd} \\ {}^{B} {\dot{ω}}_{b}^{cmd}\end{matrix} ] ∈ .$$

(2) Foot-end trajectory tracking task: the foot end trajectory tracking task is also a basic task for the movement of the quadruped robot, which is indispensable. For a foot end of the l-th leg, according to (non-rotational) acceleration-level kinematics, it follows that:

$${\ddot{x}}_{c , l} = {J}_{c , l} ( {q}_{g} ) \ddot{q} + {\dot{J}}_{c , l} ( {q}_{g} ) \dot{q} .$$

Therefore, a corresponding matrix and a corresponding vector for a foot-end trajectory tracking subtask of the l-th leg can be written as:

$${A}_{2 , l} = [ \begin{matrix}{J}_{c , l} ( {q}_{g}^{fb} ) & {0}_{3 \times {n}_{F}} ] ∈\end{matrix} ,$$

$${b}_{2 , l} = {\ddot{x}}_{c , l}^{cmd} - {\dot{J}}_{c , l} ( {q}_{g}^{fb} ) {\dot{q}}^{fb} ∈ , and$$

$$l = 1 , 2 , 3 , 4 ,$$

where

$${\ddot{x}}_{c , l}^{cmd} ∈$$

is a linear acceleration instruction of the foot end of the l-th leg in the inertial system I. When the leg is under different states, the instruction varies.

For example, when the leg acts as the supporting leg, the foot end should be fixed on the ground without movement, i.e.,

$${\ddot{x}}_{c , l}^{cmd} = {0}_{3 \times 1} .$$

When the leg acts as the supporting leg but does not touch the ground (delayed contact with the ground),

$${\ddot{x}}_{c , l}^{cmd}$$

is micro-control to track a velocity pointing to the collision surface, and

$${\ddot{x}}_{c , l}^{cmd} = {K}_{p , {x}_{c , l}} ( - {𝓋}_{imp} n - {\dot{x}}_{c , l}^{fb} ) ,$$

where νᵢₘₚ∈ [symbol] is an artificially specified desired collision velocity, and n∈ [symbol] is the unit normal vector of the collision surface previously mentioned, pointing outwardly from the collision surface. When the leg acts as the swing leg,

$${\ddot{x}}_{c , l}^{cmd}$$

is obtained by the PD control:

$${\ddot{x}}_{c , l}^{cmd} = {K}_{p , {x}_{c , l}} ( {x}_{c , l}^{TO} - {x}_{c , l}^{fb} ) + {K}_{d , {x}_{c , l}} ( {\dot{x}}_{c , l}^{TO} - {\dot{x}}_{c , l}^{fb} ) ,$$

where K_{p,x}_{_{c,l}}, K_{d,x}_{_{c,l}}∈ [symbol] is the PD gain coefficient matrices, both of which are diagonal matrices.

$${x}_{c , l}^{TO} , {\dot{x}}_{c , l}^{TO}$$

are the optimal reference point position and the linear velocity of the foot end of the swing leg calculated in the above embodiments.

It should be noted that foot-end trajectory tracking subtasks of four legs in the embodiments of the present disclosure together constitute a complete foot-end trajectory tracking task. Therefore, the corresponding matrix and the corresponding vector can be written as:

$${A}_{2} = [ \begin{matrix}{A}_{2 , 1} \\ {A}_{2 , 2} \\ {A}_{2 , 3} \\ {A}_{2 , 4}\end{matrix} ] ∈ and {b}_{2} = [ \begin{matrix}{b}_{2 , 1} \\ {b}_{2 , 2} \\ {b}_{2 , 3} \\ {b}_{2 , 4}\end{matrix} ] ∈ , respectively .$$

(3) Foot-sole Force Tracking Task: a linear momentum and an angular momentum of a center of mass of the quadruped robot are affected not only by the gravitational force but also by the ground reaction force on the foot end (i.e., the foot-sole force). During high-dynamic movement, appropriate foot-sole forces are very important.

The embodiments of the present disclosure may provide a method to optimize reference-valuable foot-sole forces

$${F}_{c}^{MPC}$$

using a single-rigid-body model MPC. Corresponding tasks need to be set in the WBC to achieve foot-sole force tracking.

Since the quadruped robot used in the embodiments of the present disclosure does not have a force/torque sensor at the foot end of the quadruped robot, it is difficult to implement foot-sole force feedback control in the WBC. Therefore, the foot-sole force tracking task can only be set as a pure feedforward force task. The corresponding matrix and the corresponding vector can be written as:

$${A}_{3} = [ {0}_{{n}_{k} \times {n}_{q}} {I}_{{n}_{F} \times {n}_{F}} ] ∈ and {b}_{3} = {F}_{c}^{ref} ∈ ,$$

respectively,

$${F}_{c}^{ref} = [ \begin{matrix}{F}_{c , 1}^{ref} \\ {F}_{c , 2}^{ref} \\ {F}_{c , 3}^{ref} \\ {F}_{c , 4}^{ref}\end{matrix} ] .$$

where
When the l-th leg touches the ground and acts as the supporting leg, the leg may execute the reference foot-sole force provided by the MPC. Therefore,

$${F}_{c , l}^{ref} = {F}_{c , l}^{MPC} .$$

When the leg is the swing leg or is the supporting leg in planning but does not touch the ground (i.e., delayed contact with the ground), the foot end of the leg is not subjected to an external force. Therefore,

$${F}_{c , l}^{ref} = {0}_{3 \times 1} .$$

(4) Task of Minimizing Variation of Joint Torque: due to a limited bandwidth of actual motor force control, excessively drastic changes in the output torque are difficult for practical implementation. When the actual motor cannot execute actions according to an optimal solution of the WBC, the control error tends to increase. Therefore, the embodiments of the present disclosure can incorporate consideration of “reducing variation of the joint torque” into the WBC, making it easier for the actual motor to execute actions according to the optimal solution of the WBC.

Assuming that an optimal joint torque instruction calculated by the WBC in a previous control cycle is

$${τ}_{j}^{pre} ∈ ,$$

a matrix and a vector for the task of minimizing variation of a joint Torque in this control cycle can be written as:

$${A}_{4} = [ {S}_{j} M ( {q}_{g}^{fb} ) - {S}_{j} {J}_{c}^{T} ( {q}_{g}^{fb} ) ] ∈ and$$

$${b}_{4} = {τ}_{j}^{pre} \to {S}_{j} h ( {q}_{g}^{f b} , {\dot{q}}^{fb} ) ∈ , respectively .$$

It should be noted that this task may potentially conflict with the previously mentioned tasks, including the trunk trajectory tracking task, the foot-end trajectory tracking task, and the foot-sole force tracking task. Therefore, in the embodiments of the present disclosure, a weight assigned to this task may not be too high. Otherwise, execution performance of the above tasks may be affected.

(4) Task of Minimizing Variation of Foot-sole Force: to make variation in the foot-sole force smoother (thus making state variation of the center of mass smoother), the embodiments of the present disclosure can incorporate a task of “reducing variation of the foot-sole force” in the WBC.

Assume that an optimal foot-sole force calculated by the WBC in the previous control cycle is

$${F}_{c}^{pre} ∈ ,$$

a matrix and a vector for the task of minimizing variation of the foot-sole force in this control cycle can be written as:

$${A}_{5} = [ {0}_{{n}_{F} \times {n}_{q}} {I}_{{n}_{F} \times {n}_{F}} ] ∈ and {b}_{5} = {F}_{c}^{pre} ∈ ,$$

respectively.

It should be noted that, similarly, this task may potentially conflict with the previously mentioned tasks, including the trunk trajectory tracking task, the foot-end trajectory tracking task, and the foot-sole force tracking task. Therefore, the weight assigned to this task may not be too high. Otherwise, execution performance of the other tasks may be affected.

### III. Constraint Settings

(1) Floating Base Dynamic Equality Constraint: a trunk of the quadruped robot does not have a direct driving force and a torque. Therefore, the first six rows of a complete movement equation do not include a joint output torque. These six rows are floating base dynamic equations, which are equality constraints that need to be satisfied. A corresponding matrix and a corresponding vector are:

$${C}_{1} = [ {S}_{b} M ( {q}_{g}^{fb} ) - {S}_{b} {J}_{c}^{T} ( {q}_{g}^{fb} ) ] ∈ and$$

$${lb}_{1} = u {b}_{1} = - {S}_{b} h ( {q}_{g}^{fb} , {\dot{q}}^{fg} ) ∈ , repectively ,$$

where S_{b}=[I_{6×6} 0_{6×n}_{ⱼ}]∈ [symbol] is a selection matrix of the floating base.

(2) Foot-sole Force Inequality Constraint: to avoid sliding of the foot end of the supporting leg relative to the ground, a ratio of a magnitude of a component parallel to a contact surface in the foot-sole force to a magnitude of a component perpendicular to the contact surface in the foot-sole force is smaller than a friction coefficient. That is, a foot-sole force of F_{c,l} of the l-th leg may satisfy the following constraint to avoid slipping: ∥(I_{3×3}−nn^{T})F_{c,l}∥₂≤μ|n^{T}F_{c,l}|, where μ is the friction coefficient.

It should be understood that the above formula describes a conical region. Therefore, this constraint for avoiding foot-end slippage is also called a friction cone constraint. Since the formula includes a norm [symbol] ₂, which is a nonlinear expression, for the convenience of solving the WBC optimization problem, the embodiments of the present disclosure can simplify the formula.

In the embodiments of the present disclosure, the formula can be linearized, i.e., using a tetrahedral cone instead of a circular cone. Then, assuming that the quadruped robot usually walks on a flat ground with a slope close to zero, a Z-axis component of F_{c,l} can be considered as the component perpendicular to the contact surface. Therefore, the above formula can be rewritten as:

$$\{ \begin{matrix}\vert {F}_{c , l , x} \vert \leq μ \vert {F}_{c , l , z} \vert \\ \vert {F}_{c , l , y} \vert \leq μ \vert {F}_{c , l , z} \vert\end{matrix} .$$

It should be noted that the foot-sole force is the ground reaction force on the foot sole, and thus the Z-axis component is always greater than zero. To avoid an excessively large foot-sole force from being optimized and causing hardware damage, the embodiments of the present disclosure may also have a limit on a magnitude of the Z-axis component of F_{c,l}. Therefore, a foot-sole force inequality constraint for the l-th leg can be written as:

$$\{ \begin{matrix}\vert {F}_{c , l , x} \vert \leq μ {F}_{c , l , z} \\ \vert {F}_{c , l , y} \vert \leq μ {F}_{c , l , z} \\ 0 \leq {F}_{c , l , z} \leq {F}_{c , l , {z}_{max}}\end{matrix} ,$$

where F_{c,l,z}_{ₘₐₓ}∈ [symbol] is an artificially specified maximum foot-sole force in a Z-axis direction. When this leg is already the supporting leg, F_{c,l,z}_{ₘₐₓ} is a predetermined positive number. When this leg is the swing leg or is the supporting leg in planning but does not touch the ground (delayed contact with the ground), a foot-sole force of this leg is zero. Therefore, F_{c,l,z}_{ₘₐₓ}=0. In the embodiments of the present disclosure, the above expression can equivalently be represented in matrix form as:

$${0}_{5 \times 1} \leq {C}_{F} {F}_{c , l} \leq u {b}_{F} ,$$

$$where {C}_{F} = [ \begin{matrix}1 & 0 & μ \\ - 1 & 0 & μ \\ 0 & 1 & μ \\ 0 & - 1 & μ \\ 0 & 0 & 1\end{matrix} ] ∈ , {ub}_{F} = [ \begin{matrix}+ ∞ \\ + ∞ \\ + ∞ \\ + ∞ \\ {F}_{c , l , {z}_{max}}\end{matrix} ] ∈ .$$

The final foot-sole force constraints for all four legs, when combined, constitute a complete foot force inequality constraint. A corresponding matrix and a corresponding vector can be written as:

$${C}_{2} = [ \begin{matrix} & {C}_{F} & & & \\ & & {C}_{F} & & \\ {0}_{20 \times {n}_{q}} & & & {C}_{F} & \\ & & & & {C}_{F}\end{matrix} ] ∈ and$$

$${lb}_{2} = {0}_{20 \times 1} , {ub}_{2} = [ \begin{matrix}{ub}_{F} \\ {ub}_{F} \\ {ub}_{F} \\ {ub}_{F}\end{matrix} ] ∈ , respectively .$$

(3) Joint Output Torque Saturation Inequality Constraint: performance of the actual motor is limited. Even in a stalled state, there is an upper limit to the output torque thereof. In the WBC, output torque limits of the actual motor need to be considered to better coordinate various joints to simultaneously complete multiple desired tasks. Therefore, a matrix and a vector for the joint output torque saturation inequality constraint can be written as:

$${C}_{3} = [ \begin{matrix}{S}_{j} M ( {q}_{g}^{fb} ) & - {S}_{j} {J}_{c}^{T} ( {q}_{g}^{fb} )\end{matrix} ] ∈ {ℛ}^{{n}_{j} \times {n}_{χ}}$$

$$l {b}_{3} = {τ}_{j , min} - {S}_{j} h ( {q}_{g}^{fb} , {\dot{q}}^{fb} ) ∈ {ℛ}^{{n}_{j}} , and$$

$${ub}_{3} = {τ}_{j , max} - {S}_{j} h ( {q}_{g}^{fb} , {\dot{q}}^{fb} ) ∈ {ℛ}^{{n}_{j}} , respectively ,$$

where Σ_{j,min}, τ_{j,max} are a lower limit and an upper limit of the joint output torque, respectively.

(4) Joint Rotational Speed Saturation Inequality Constraint: similar to the joint output torque saturation inequality constraint, even under no-load conditions, there is an upper limit to the rotational speed of the actual motor. In the WBC, rotational speed limits of the actual motor need to be considered to better coordinate various joints to simultaneously complete multiple desired tasks.

Performing a Taylor expansion on the joint rotational speed at a moment of t and ignoring a higher-order term beyond acceleration, in the embodiments of the present disclosure, \dot{q}ⱼ(t+δt) can be linearly predicted:

$${\dot{q}}_{j} ( t + δ t ) \approx {\dot{q}}_{j} ( t ) + δ t {\ddot{q}}_{j} ( t ) .$$

In a same control cycle, the embodiments of the present disclosure can take a joint rotational speed

$${\dot{q}}_{j}^{fb}$$

from a latest feedback as a joint rotational speed \dot{q}ⱼ(t) at a current moment, and use a joint acceleration from an optimization variable as a joint acceleration \ddot{q}ⱼ(t) at the current moment. In this way, using the above formula, a joint rotational speed at a moment t+δt can be linearly represented by the optimization variable. Therefore, a corresponding matrix and a corresponding vector for the joint rotational speed saturation inequality constraint are:

$${C}_{4} = [ \begin{matrix}{0}_{{n}_{j} \times 6} & {I}_{{n}_{j} \times {n}_{j}} & {0}_{{n}_{j} \times {n}_{F}}\end{matrix} ] ∈ {ℛ}^{{n}_{j} \times {n}_{χ}}$$

$$l {b}_{4} = {\dot{q}}_{j , min} - {\dot{q}}_{j}^{fb} ∈ {ℛ}^{{n}_{j}} , and$$

$${ub}_{4} = {\dot{q}}_{j , max} - {\dot{q}}_{j}^{fb} ∈ {ℛ}^{{n}_{j}} , respectively ,$$

where \dot{q}_{j,min},\dot{q}_{j,max} are a lower limit and an upper limit of the joint rotational speed, respectively.

(5) Joint Output Power Saturation Inequality Constraint: similar to the joint output torque saturation inequality constraint, an output power of the actual motor also has an upper limit. In the WBC, output power limits of the actual motor need to be considered to better coordinate various joints to simultaneously complete multiple desired tasks. Considering that an environment may also do work on the motor, the embodiments of the present disclosure do not constrain an input power of the joint but only constrain an output power of the joint.

For an α-th joint, let an output torque of the α-th joint be τ_{α}∈ [symbol] , and an output rotational speed of the α-th joint be \dot{q}_{α}∈ [symbol] , then, the output power of this joint is P_{α}=τ_{α}\dot{q}_{α}. Let an output power of nⱼ-th joint be Pⱼ∈ [symbol] , then it follows that:

$${P}_{j} = diag ( {\dot{q}}_{j} ) {τ}_{j} .$$

The rotational speed of the joint can be represented by

$${\dot{q}}_{j}^{fb} ,$$

and the output torque of the joint can be linearly expressed using the optimization variable. Therefore, a matrix and a vector corresponding to the joint output power saturation inequality constraint are:

$${C}_{5} = diag ( {\dot{q}}_{j} ) [ \begin{matrix}{S}_{j} M ( {q}_{g}^{fb} ) & - {S}_{j} {J}_{c}^{T} ( {q}_{g}^{fb} )\end{matrix} ] ∈ {ℛ}^{{n}_{j} \times {n}_{χ}}$$

$$l {b}_{5} = - {∞}_{{n}_{j} \times 1} , and$$

$${ub}_{5} = {P}_{j , max} - diag ( {\dot{q}}_{j} ) {S}_{j} h ( {q}_{g}^{fb} , {\dot{q}}^{fb} ) ∈ {ℛ}^{{n}_{j}} , respectively ,$$

where P_{j,max}∈ [symbol] is an upper limit of the joint output power.

(6) Impact-aware Constraint: the impact-aware constraint in the WBC is similar to that in the TO, and the same discrete collision model, i.e., the discrete collision dynamic model, is used.

It should be understood that in the WBC, assuming the collision occurs at the next moment (i.e., a moment t+δt), in the embodiments of the present disclosure, the Taylor expansion formula can be used to predict a linear velocity of the foot end before a next collision. Then, a sudden change in the foot-sole linear velocity caused by the collision is predicted, followed by predicting an impulse generated by the collision. Finally, this impulse is constrained in a current control cycle. Therefore, a joint acceleration optimized by the WBC can cause the linear velocity of the foot end to be sufficiently small, in such a manner that if a collision really occurs at the next moment, the resulting impulse may fall within an impact-aware constraint range of the WBC. If no collision occurs at the next moment, the robot may show a significant reduction in a movement velocity of the foot end.

In an exemplary embodiment of the present disclosure, for the l-th leg, according to kinematics of the robot and the Taylor expansion formula, the pre-collision foot-end linear velocity

$${\dot{x}}_{c , l , next}^{-}$$

at the moment t+δt may be predicted linearly using the joint acceleration in the optimization variable:

$${\dot{x}}_{c , l , next}^{-} \approx {\dot{x}}_{c , l}^{fb} + δ t {\ddot{x}}_{c , l} = {J}_{c , l} ( {q}_{g}^{fb} ) {\dot{q}}^{fb} + δ t ( {\dot{J}}_{c , l} ( {q}_{g}^{fb} ) {\dot{q}}^{fb} + {J}_{c , l} ( {q}_{g}^{fb} ) \ddot{q} ) ,$$

Substituting the above equation into the discrete collision dynamic model and

$${Λ}_{c} Δ {\dot{x}}_{c} = {Λ}_{c} ( {\dot{x}}_{c}^{+} - {\dot{x}}_{c}^{-} ) = {ι}_{c} ,$$

the predicted sudden change in the foot-sole linear velocity Δ\dot{x}_{c,l,next} caused by the collision can be expressed linearly using the joint acceleration in the optimization variable:

$$Δ {\dot{x}}_{c , l , next} = - ( 1 + {c}_{r} ) {P}_{n} {\dot{x}}_{c , l , next}^{-} \approx - ( 1 + {c}_{r} ) {P}_{n} ( {J}_{c , l} ( {q}_{g}^{fb} ) {\dot{q}}^{fb} + δ t ( {\dot{J}}_{c , l} ( {q}_{g}^{fb} ) {\dot{q}}^{fb} + {J}_{c , l} ( {q}_{g}^{fb} ) \ddot{q} ) ) ,$$

a predicted collision impulse of l_{c,l,next} can be expressed linearly using the joint acceleration in the optimization variable:

$${ι}_{c , l , next} = {Λ}_{c , l} ( {q}_{g}^{fb} ) Δ {\dot{x}}_{c , l , next} \approx - ( 1 + {c}_{r} ) {Λ}_{c , l} ( {q}_{g}^{fb} ) {P}_{n} ( {J}_{c , l} ( {q}_{g}^{fb} ) {\dot{q}}^{fb} + δ t ( {\dot{J}}_{c , l} ( {q}_{g}^{fb} ) {\dot{q}}^{fb} + {J}_{c , l} ( {q}_{g}^{fb} ) \ddot{q} ) ) .$$

Therefore, the impact-aware constraint is obtained, and expressions of a matrix and a vector thereof are:

$${C}_{6 , l} = [ - δ t ( 1 + {c}_{r} ) {Λ}_{c , l} ( {q}_{g}^{fb} ) {P}_{n} \begin{matrix}{J}_{c , l} ( {q}_{g}^{fb} ) & {0}_{3 \times {n}_{F}}\end{matrix} ] ∈ {ℛ}^{3 \times {n}_{χ}} ,$$

$$l {b}_{6} = {ι}_{c , l , min} + ( 1 + {c}_{r} ) {Λ}_{c , l} ( {q}_{g}^{fb} ) {P}_{n} ( {J}_{c , l} ( {q}_{g}^{fb} ) {\dot{q}}^{fb} + δ t {\dot{J}}_{c , l} ( {q}_{g}^{fb} ) {\dot{q}}^{fb} ) ∈ {ℛ}^{3} ,$$

$${ub}_{6} = {ι}_{c , l , max} + ( 1 + {c}_{r} ) {Λ}_{c , l} ( {q}_{g}^{fb} ) {P}_{n} ( {J}_{c , l} ( {q}_{g}^{fb} ) {\dot{q}}^{fb} + δ t {\dot{J}}_{c , l} ( {q}_{g}^{fb} ) {\dot{q}}^{fb} ) ∈ {ℛ}^{3} ,$$

where l_{c,l,min}, l_{c,l,max}∈ [symbol] are an artificially specified lower limit and an artificially specified upper limit of the allowable collision impulse, respectively, and t represents a time interval between the current moment and the next moment.

It should be understood that when the leg is the swing leg in planning or already makes contact with the ground and becomes the supporting leg, the leg does not need the impact-aware constraint. Conversely, when the leg is the supporting leg in planning but does not touch the ground (i.e., delayed contact with the ground), the leg needs to enable a corresponding impact-aware constraint.

In an exemplary embodiment of the present disclosure, the performing, based on the movement state, the reference state sequence, and the foot-end reference state, whole-body control on the legged robot includes: if a leg is a swing leg in planning, setting the foot-end trajectory tracking task as tracking the impact-aware swing leg trajectory, setting a target foot-sole force of the foot-sole force tracking task as a predetermined value, setting a foot-sole force constraint in the foot-sole force inequality constraint as a predetermined value, and disabling the impact-aware constraint; if a leg is the supporting leg in planning and touches the ground, setting a target linear acceleration of the foot-end trajectory tracking task as a predetermined value, setting the target foot-sole force of the foot-sole force tracking task as a foot-sole force provided by MPC or another module, setting the foot-sole force constraint as a friction cone constraint, and disabling the impact-aware constraint; and if a leg is a supporting leg in planning but does not touch the ground, setting a target of the foot-end trajectory tracking task as tracking a velocity pointing to an collision surface, setting the target foot-sole force of the foot-sole force tracking task as a predetermined value, setting the foot-sole force constraint as a predetermined value, and enabling the impact-aware constraint.

A module that can provide the target foot-sole force for the foot-sole force tracking task may include the above MPC module. The predetermined value of the target foot-sole force of the foot-sole force tracking task, the predetermined value of the foot-sole force constraint in the inequality constraint, and the predetermined value of the target line acceleration for the tracking task may be 0. In the embodiments of the present disclosure, a predetermined value of 0 as an example is described.

It should be noted that the embodiments of the present disclosure can further predict an effect of the collision on a joint space, such as predicting a torque effect of the collision on the joint caused by a collision impulse mapped onto each joint. However, under normal circumstances, as long as an impulse caused by the collision in the operation space is small enough, the effect of the collision in the joint space may also not be significant. To maximize a computational efficiency of the WBC, the impact-aware constraint in the embodiments of the present disclosure is only limited to the operation space, which is consistent with the trajectory optimization method in the above embodiments.

### IV. Implementation Decision of Whole-Body Control

It should be understood that in the WBC of the embodiments of the present disclosure, there are always three unchanging task settings, namely the trunk trajectory tracking task, the task of minimizing variation of the joint torque, and the task of minimizing variation of the foot-sole force. There are always four unchanging constraint settings, namely the floating-base dynamic equality constraint, a motor output torque saturation inequality constraint, a motor output rotational speed saturation inequality constraint, and a motor output power saturation inequality constraint. Other tasks and constraints vary under different circumstances, specifically the foot-end trajectory tracking task, the foot-sole force tracking task, the foot-sole force inequality constraint, and the impact-aware constraint.

It should be noted that as illustrated in FIG. 3, when the leg is the swing leg in planning, if the WBC enables the corresponding impact-aware constraint while the leg acts as the swing leg, there are following two scenarios. In one scenario, since the TO already includes the impact-aware constraint, a reference linear velocity of the foot end of the leg is inherently very small, in this case, the optimal solution from WBC optimization does not lie on a boundary of the corresponding impact-aware constraint, that is, the corresponding impact-aware constraint in the WBC does not take effect. In another scenario, the optimal solution from WBC optimization lies on the boundary of the corresponding impact-aware constraint, meaning this constraint takes effect, a movement velocity of the foot end of the leg may be even lower than the reference linear velocity given by the TO, therefore, ground contact cannot be achieved by the foot end of the leg at a designated ground contact time point by the TO, that is, delayed contact with the ground occurs. From this, it may be concluded that when the leg is the swing leg in planning, if the impact-aware constraint of the leg is enabled in the WBC, no effect or a negative effect may occur. Therefore, the impact-aware constraint in the WBC may only be enabled upon occurrence of contact with the ground.

Further, when the leg is the supporting leg in planning but does not touch the ground (i.e., delayed contact with the ground), a target of the foot-end trajectory tracking task is to track a velocity −νᵢₘₚn pointing to the collision surface, where νᵢₘₚ does not need to be set too small, otherwise significant delayed contact with the ground may occur. However, there is no need to consider setting a large νᵢₘₚ which may lead to a large collision velocity, since the impact-aware constraint can limit a velocity of the foot end. Each leg of the legged robot in the embodiments of the present disclosure can perform judgment according to the decision tree illustrated in FIG. 3, thereby determining expressions of all tasks and constraints, i.e., determining an expression of the WQP.

In summary, with the planning and control method for the legged robot according to the embodiments of the present disclosure, simplification of the foot-end dynamic model and the trajectory optimization of the discrete collision model can be performed. For an issue of an early collision, planning is performed during swinging to enable an influence caused by the early collision to be within the target constraint range. Also, the whole-body control can be performed on the legged robot based on the whole-body dynamic model and the discrete collision model. For an issue of the delayed collision, processing is performed at a control stage to enable an influence caused by the delayed collision to be within the target constraint range. By concurrently addressing the early collision and the delayed collision, the embodiments of the present disclosure can mitigate an impact force generated at an instant of collision between the foot sole and the ground, which can further reduce an influence of the collision. Therefore, stability of the movement state of the robot can be enhanced, improving a hardware service life of the robot.

Then, a planning and control apparatus for the legged robot according to the embodiments of the present disclosure is described with reference to the accompanying drawings.

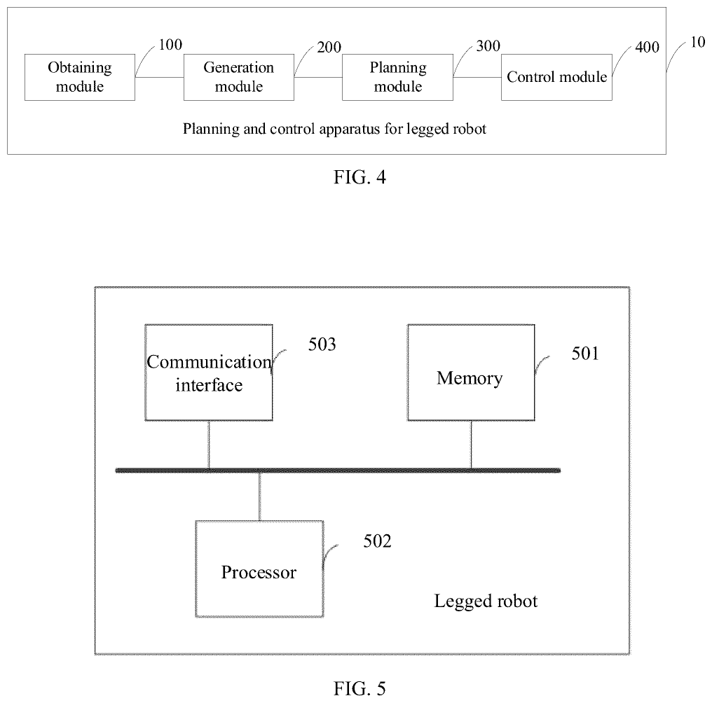

FIG. 4 is a block diagram of the planning and control apparatus for the legged robot according to an embodiment of the present disclosure.

As illustrated in FIG. 4, a planning and control apparatus 10 for the legged robot includes: an obtaining module 100, a generation module 200, a planning module 300, and a control module 400.

The obtaining module 100 is configured to obtain a movement instruction and a movement state of the legged robot. The generation module 200 is configured to generate, based on the movement instruction and the movement state, a reference state sequence of the legged robot and a swing parameter of each leg at a next moment. The planning module 300 is configured to determine, based on the movement state and the swing parameter of each leg at the next moment, a foot-end reference state of each leg, and plan, based on a foot-end dynamic model and a discrete collision model, an impact-aware swing leg trajectory for a leg that starts to swing at the next moment, to enable an influence caused by an early collision to be within a target constraint range. The control module 400 is configured to perform, based on the movement state, the reference state sequence, and the foot-end reference state, whole-body control on the legged robot, and perform, based on a whole-body dynamic model and the discrete collision model, impact-aware whole-body control for a leg that is a supporting leg in planning but does not touch the ground, to enable an influence caused by a delayed collision to be within the target constraint range.

In the embodiments of the present disclosure, the foot-end dynamic model of the planning and control apparatus for the legged robot is:

$${Λ}_{c , l} {\ddot{x}}_{c , l} + {h}_{c , l} = {F}_{j} ,$$

where \ddot{x}_{c,l}∈ [symbol] is the linear acceleration of the foot end of the l-th leg in the inertial system I, Λ_{c,l} is the mass matrix in the operation space, h_{c,l} is the term including the Coriolis force, the centripetal force, and the gravitational force in the operation space, and Fⱼ∈ [symbol] is the foot-end driving force obtained by mapping the torque τⱼ of the driving joint to the operation space. The discrete collision model is:

$$Δ {\dot{x}}_{c , l} = {P}_{n} ( {\dot{x}}_{1}^{+} - {\dot{x}}_{1}^{-} ) = - ( 1 + {c}_{r} ) {P}_{n} {\dot{x}}_{c , l}^{-} ,$$

where Pₙ=nn^{T}∈ [symbol] is the projection operator on the collision normal vector, n∈ [symbol] is the unit normal vector of the collision surface,

$${\dot{x}}_{1}^{+} {\dot{x}}_{1}^{-} ∈ {ℛ}^{3}$$

are the velocity of the first object before collision and the velocity of the first object after the collision, respectively,

$${\dot{x}}_{2}^{+} , {\dot{x}}_{2}^{-} ∈ {ℛ}^{3}$$

are the velocity of the second object before collision and the velocity of the second object after the collision, respectively, and cᵣ is the restitution coefficient.

In the embodiments of the present disclosure, the planning module is further configured to: obtain the pre-defined state variable and the target constraint condition; construct, based on the foot-end dynamic model, the pre-defined state variable, and the target constraint condition, the continuous-time trajectory optimization problem for the leg that starts to swing at the next moment; and discretize the continuous-time trajectory optimization problem to obtain the discrete-time trajectory optimization problem for the foot end of the swing leg, and solve the discrete-time trajectory optimization problem to obtain the impact-aware swing leg trajectory.

In the embodiments of the present disclosure, the pre-defined state variable of the planning module includes one or more of: the initial state of the foot end of the swing leg, the touchdown state of the foot end of the swing leg, the swing duration, and the desired maximum height of the foot end of the swing leg from the ground. The target constraint condition includes one or more of: the state equation equality constraint, the driving force inequality constraint, the trajectory height inequality constraint, the initial state equality constraint, the terminal state equality constraint, the impact-aware inequality constraint, and the terminal velocity direction inequality constraint.

In the embodiments of the present disclosure, the objective function of the continuous-time trajectory optimization problem of the planning module is:

$${min}_{x ( t ) , u ( t )} {f}_{TO} = {‖ x ( {t}_{F} ) - [ \begin{matrix}{x}_{c , F}^{ref} \\ {\dot{x}}_{c , F}^{ref}\end{matrix} ] ‖}_{{Q}_{{x}_{F}}} + {\int }_{{t}_{0}}^{{t}_{F}} {‖ u ( τ ) ‖}_{{Q}_{u}} d τ + {\int }_{{t}_{{h}_{1}}}^{{t}_{{h}_{2}}} {‖ {z}_{c} ( τ ) - {z}_{h}^{ref} ‖}_{{Q}_{z}} d τ ,$$

where Qₓ_{_{F}}∈ [symbol] , Qᵤ∈ [symbol] , and Q_{z}∈ [symbol] are weight matrices (mostly diagonal matrices) with different dimensions, ∥a∥=a^{T}Qa represents the weighted norm of the vector a under the weight matrix Q,

$${‖ x ( {t}_{F} ) - [ \begin{matrix}{x}_{c , F}^{ref} \\ {\dot{x}}_{c , F}^{ref}\end{matrix} ] ‖}_{{Q}_{{x}_{F}}}$$

reflects the task of the touchdown state of the foot end of the swing leg,

$${x}_{c , F}^{ref} ∈ {ℛ}^{3} and {\dot{x}}_{c , F}^{ref} ∈ {ℛ}^{3}$$

are the known terminal position of the foot end of the swing leg and the known linear velocity of the foot end of the swing leg, respectively,

$${\int }_{{t}_{0}}^{{t}_{F}} {‖ u ( τ ) ‖}_{{Q}_{u}} d τ$$

is the minimum control variable (i.e., the linear acceleration) in the entire swing process, and t₀=0, t_{F}=T_{sw}, where T_{sw} is the swing duration,

$${\int }_{{t}_{{h}_{1}}}^{{t}_{{h}_{2}}} {‖ {z}_{c} ( τ ) - {z}_{h}^{ref} ‖}_{{Q}_{z}} d τ$$

reflects the task of the maximum height of the swing leg from the ground, tₕ₁ and tₕ₂ are parameters specifying the time period to reach the maximum height, satisfying t₀≤tₕ₁≤tₕ₂≤t_{F}, and z_{c} is the third component of the state variable, i.e., the component representing the height of the foot end from the ground in the state variable. The discrete-time trajectory optimization problem is:

$${min}_{U} {f}_{c , TO} = {‖ {x}_{N} - {x}_{N}^{ref} ‖}_{{Q}_{{x}_{N}}} + {\sum }_{k = 0}^{N - 1} {‖ {u}_{k} ‖}_{{Q}_{{u}_{k}}} + {\sum }_{k = {k}_{{h}_{1}}}^{{k}_{{h}_{2}}} {‖ {S}_{z} {x}_{k} - {z}_{h}^{ref} ‖}_{{Q}_{{z}_{k}}} ,$$

$$s . t . {\underbrace{[ \begin{matrix}{x}_{c , k + 1} \\ {\dot{x}}_{c , k + 1}\end{matrix} ]}}_{{x}_{k + 1}} = {\underbrace{[ \begin{matrix}{I}_{3 \times 3} & Δ {tI}_{3 \times 3} \\ {0}_{3 \times 3} & {I}_{3 \times 3}\end{matrix} ]}}_{A} {\underbrace{[ \begin{matrix}{x}_{c , k} \\ {\dot{x}}_{c , k}\end{matrix} ]}}_{{x}_{k}} + {\underbrace{[ \begin{matrix}\frac{1}{2} Δ {t}^{2} {I}_{3 \times 3} \\ Δ {tI}_{3 \times 3}\end{matrix} ]}}_{B} {\underbrace{{\ddot{x}}_{c , k}}}_{{u}_{k}} , k = 0 , 1 , … , N - 1 ,$$

$${f}_{min} \leq {Λ}_{c} {u}_{k} + {h}_{c} \leq {f}_{max} , k = 0 , 1 , … , N - 1 ,$$

$${z}_{c , min} \leq {S}_{z} {x}_{k} \leq {z}_{c , max} , k = 1 , 2 , … , N - 1 ,$$

$${x}_{0} = {x}_{0}^{fb} ,$$

$${S}_{z , \dot{z}} {x}_{N} = {S}_{z , \dot{z}} {x}_{N}^{ref} ,$$

$${ι}_{c , min} ⩽ {Λ}_{c} [ - ( 1 + {c}_{r} ) {P}_{n} {S}_{v} {x}_{k} ] ⩽ {ι}_{c , max} , k = {k}_{imp} , {k}_{imp} + 1 , … , N ,$$

$$( {C}_{{ℓ}_{1}} + \frac{1}{cos {θ}_{c , max}} {D}_{n} ) {S}_{v} {\dot{x}}_{k} \leq {0}_{4 \times 1} , k = {k}_{imp} , {k}_{imp} + 1 , … , N .$$

where

$$U = {[ {u}_{0}^{T} , {u}_{1}^{T} , … , {u}_{N - 1}^{T} ]}^{T} ∈ {ℛ}^{3 N}$$

is the vector composed of the control variable of each frame, Qₓ_{_{N}}∈ [symbol] , Qᵤ_{ₖ}∈ [symbol] , and Q_{z}_{ₖ}∈ [symbol] are diagonal weight matrices with different dimensions,

$${x}_{0}^{f b} = [ \begin{matrix}{x}_{c , 0}^{fb} \\ {\dot{x}}_{c , 0}^{fb}\end{matrix} ] {ℛ}^{6}$$

is the feedback of the foot-end state (including the position and the velocity) at the current moment,

$${x}_{N}^{ref} = [ \begin{matrix}{x}_{c , F}^{ref} \\ {\dot{x}}_{c , F}^{ref}\end{matrix} ] ∈ {ℛ}^{6}$$

is the reference terminal foot-end state (including the position and the velocity), S_{ν}[0_{3×3}I_{3×3}]∈ [symbol] is the selection matrix of the foot-end linear velocity, kₕ_{₁} and kₕ_{₂} are the artificially specified start frame and the artificially specified end frame for maintaining the swing height, satisfying 0≤kₕ₁≤kₕ_{₂}<N, and kᵢₘₚ is the start frame for enabling the impact-aware constraint and the terminal velocity direction constraint, satisfying 0≤kᵢₘₚ≤N.

In the embodiments of the present disclosure, the optimization problem of the whole-body control of the planning and control apparatus for the legged robot is:

$${min}_{χ} {\sum }_{i = 1}^{{n}_{task}} {‖ {W}_{i} ( {A}_{i} χ - {b}_{i} ) ‖}_{2}^{2} ,$$

$$s . t . l {b}_{j} \leq {C}_{j} χ \leq {ub}_{j} , j = 1 , 2 , … , {n}_{constraint} ,$$

where Aᵢ is the task matrix, bᵢ is the task vector, cⱼ is the constraint matrix, lbⱼ and ubⱼ are the lower constraint bound and the upper constraint bound, Wᵢ is the weight matrix, nₜₐₛₖ is the quantity of tasks, and n_{constraint} is the quantity of constraints.

In the embodiments of the present disclosure, the tasks processed simultaneously by the whole-body control include the two or more of: the trunk trajectory tracking task, the foot-end trajectory tracking task, the foot-sole force tracking task, the task of minimizing variation of a joint torque, and the task of minimizing variation of the foot-sole force. The constraints processed simultaneously by the impact-aware whole-body control include the two or more of: the floating-base dynamic equality constraint, the foot-sole force inequality constraint, the joint output torque saturation inequality constraint, the joint rotational speed saturation inequality constraint, the joint output power saturation inequality constraint, and the impact-aware constraint.

In the embodiments of the present disclosure, the performing, based on the movement state, the reference state sequence, and the foot-end reference state, whole-body control on the legged robot includes: if the leg is the swing leg in planning, setting the foot-end trajectory tracking task as tracking the impact-aware swing leg trajectory, setting the target foot-sole force of the foot-sole force tracking task as the predetermined value, setting the foot-sole force constraint in the foot-sole force inequality constraint as the predetermined value, and disabling the impact-aware constraint; if the leg is the supporting leg in planning and touches the ground, setting the target linear acceleration of the foot-end trajectory tracking task as the predetermined value, setting the target foot-sole force of the foot-sole force tracking task as the foot-sole force provided by the MPC or another module, setting the foot-sole force constraint as the friction cone constraint, and disabling the impact-aware constraint; and if the leg is the supporting leg in planning but does not touch the ground, setting the target of the foot-end trajectory tracking task as tracking the velocity pointing to the collision surface, setting the target foot-sole force of the foot-sole force tracking task as the predetermined value, setting the foot-sole force constraint as the predetermined value, and enabling the impact-aware constraint.

In the embodiments of the present disclosure, the whole-body dynamic model of the planning and control apparatus for the legged robot is:

$$M ( {q}_{g} ) \ddot{q} + h ( {q}_{g} , \dot{q} ) = [ \begin{matrix}{0}_{6 \times 1} \\ {τ}_{j}\end{matrix} ] + {J}_{c}^{T} ( {q}_{g} ) {F}_{c} ,$$

where M(q_{g})∈ [symbol] is the generalized mass matrix, h(q_{g},\dot{q})∈ [symbol] is the term including the Coriolis force, the centripetal force, and the gravitational force, τⱼ∈ [symbol] represents the output torque of the driving joint, 0_{n×m} represents the zero matrix with the size of n×m,

$${J}_{c}^{T} ( {q}_{g} )$$

and F_{c} are the augmented Jacobian matrix formed by stacking the contact Jacobian matrix of each supporting leg and the augmented foot-sole force formed by stacking the ground reaction force on the foot sole of each supporting leg, respectively, q_{g} is the generalized joint space position, \dot{q} is the generalized joint space velocity, and \ddot{q} is the generalized joint space acceleration. Expressions for a matrix and a vector of the impact-aware constraint are:

$${C}_{6 , l} = [ - δ t ( 1 + {c}_{r} ) {Λ}_{c , l} ( {q}_{g}^{fb} ) {P}_{n} \begin{matrix}{J}_{c , l} ( {q}_{g}^{fb} ) & {0}_{3 \times {n}_{F}}\end{matrix} ] ∈ {ℛ}^{3 \times {n}_{χ}} ,$$

$$l {b}_{6} = {ι}_{c , l , min} + ( 1 + {c}_{r} ) {Λ}_{c , l} ( {q}_{g}^{fb} ) {P}_{n} ( {J}_{c , l} ( {q}_{g}^{fb} ) {\dot{q}}^{fb} + δ t {\dot{J}}_{c , l} ( {q}_{g}^{fb} ) {\dot{q}}^{fb} ) ∈ {ℛ}^{3} ,$$

$$u {b}_{6} = {ι}_{c , l , max} + ( 1 + {c}_{r} ) {Λ}_{c , l} ( {q}_{g}^{fb} ) {P}_{n} ( {J}_{c , l} ( {q}_{g}^{fb} ) {\dot{q}}^{fb} + δ t {\dot{J}}_{c , l} ( {q}_{g}^{fb} ) {\dot{q}}^{fb} ) ∈ {ℛ}^{3} ,$$

where l_{c,l,min}, l_{c,l,max}∈ [symbol] are the artificially specified lower limit of the allowable collision impulse and the artificially specified upper limit of the allowable collision impulse, respectively, and δt represents the time interval between the current moment and the next moment.

It should be noted that explanation and description for the embodiment of the planning and control method of the legged robot mentioned above is also applicable to the planning and control apparatus of the legged robot of the embodiment, and thus details thereof will be omitted here.

With the planning and control apparatus for the legged robot according to the embodiments of the present disclosure, simplification of the foot-end dynamic model and the trajectory optimization of the discrete collision model can be performed. For an issue of an early collision, planning is performed during swinging to enable an influence caused by the early collision to be within the target constraint range. Also, the whole-body control can be performed on the legged robot based on the whole-body dynamic model and the discrete collision model. For an issue of the delayed collision, processing is performed at a control stage to enable an influence caused by the delayed collision to be within the target constraint range. By concurrently addressing the early collision and the delayed collision, the embodiments of the present disclosure can mitigate an impact force generated at an instant of collision between the foot sole and the ground, which can further reduce an influence of the collision. Therefore, stability of the movement state of the robot can be enhanced, improving a hardware service life of the robot.

FIG. 5 is a schematic structural diagram of a legged robot according to an embodiment of the present disclosure. The legged robot may include a memory 501, a processor 502, and a computer program stored on the memory 501 and executable on the processor 502. The processor 502 is configured to, when executing the program, implement the planning and control method for the legged robot according to the above embodiments.

Further, the legged robot further includes a communication interface 503 for communication between the memory 501 and the processor 502. The memory 501 is configured to store the computer program executable on the processor 502. The memory 501 may include a high-speed Random Access Memory (RAM), and may also include a non-volatile memory, such as at least one magnetic disk memory.

If the memory 501, the processor 502, and the communication interface 503 are implemented independently, the communication interface 503, the memory 501, and the processor 502 can be connected to one another and in communication with one another through a bus. The bus may be an Industry Standard Architecture (ISA) bus, a Peripheral Component Interconnect (PCI) bus, or an Extended Industry Standard Architecture (EISA) bus, or the like. The bus may be classified into an address bus, a data bus, a control bus, etc. For ease of representation, in FIG. 5, the bus is represented by only one thick line, which does not mean that there is only one bus or one type of bus.

In another exemplary embodiment of the present disclosure, in a specific implementation, if the memory 501, the processor 502, and the communication interface 503 are integrated at a chip to be implemented, mutual communication between the memory 501, the processor 502, and the communication interface 503 can be completed through an internal interface.

The processor 502 may be a Central Processing Unit (CPU), or an Application Specific Integrated Circuit (ASIC), or one or more integrated circuits configured to implement the embodiments of the present disclosure.

The embodiments of the present disclosure further provide a computer-readable storage medium. The computer-readable storage medium has a computer program stored thereon. The program is configured to, when executed by a processor, implement the planning and control method for the legged robot according to the above.

In the present disclosure, the description with reference to the terms “one embodiment,” “some embodiments,” “an example,” “a specific example,” or “some examples,” etc., means that specific features, structures, materials, or characteristics described in conjunction with the embodiment(s) or example(s) are included in at least one embodiment or example of the present disclosure. In the present disclosure, any illustrative reference of the above terms does not necessarily refer to the same embodiment(s) or example(s). Further, the particular features, structures, materials, or characteristics may be combined in any suitable manner in any one or N embodiments or examples. In addition, different embodiments or examples and features of different embodiments or examples described in the specification may be combined by those skilled in the art without mutual contradiction.

In addition, the terms such as “first” and “second” are only used for descriptive purposes, and cannot be understood as indicating or implying relative importance or implicitly indicating the number of indicated technical features. Therefore, the features associated with “first” and “second” may explicitly or implicitly include at least one of the features. In the description of the present disclosure, “N” means at least two, for example, two or three, unless otherwise specifically defined.

Any process or method described in the flowchart or otherwise depicted herein may be construed as representing modules, segments, or portions of code which include one or N executable instructions for implementing custom logic functions or processes. In addition, a scope of preferred embodiments of the present disclosure includes alternative implementations in which functions may be executed in an order different from that shown or discussed, instead in a substantially concurrently order or in a reverse order, which should be appreciated by those skilled in the art to which the embodiments of the present disclosure pertain.

It can be appreciated that each part of the present disclosure can be implemented in hardware, software, firmware or any combination thereof. In the above embodiments, N steps or methods can be implemented using software or firmware stored in a memory and executed by a suitable instruction execution system. For example, when implemented in hardware, as in another embodiment, it can be implemented by any one or combination of the following technologies known in the art: a discrete logic circuit having logic gate circuits for implementing logic functions on data signals, an application-specific integrated circuit with suitable combined logic gates, a programmable gate array, a field programmable gate array, etc.

Those skilled in the art can appreciate that all or part of the steps carried by the method of implementing the above embodiments can be performed by instructing the relevant hardware through the program that can be stored in a computer-readable storage medium. The program, when being executed, includes one or a combination of the steps of the method embodiment.

Although the embodiments of the present disclosure have been shown and described above, it should be understood that the above-mentioned embodiments are exemplary and should not be construed as limiting the present disclosure. Those skilled in the art can make changes, modifications, substitutions, and alternations to the above-mentioned embodiments within the scope of the present disclosure.

What is claimed is:

1. A planning and control method for a legged robot, comprising:
obtaining a movement instruction and a movement state of the legged robot;
generating, based on the movement instruction and the movement state, a reference state sequence of the legged robot and a swing parameter of each leg at a next moment;
determining, based on the movement state and the swing parameter of each leg at the next moment, a foot-end reference state of each leg, and planning, based on a foot-end dynamic model and a discrete collision model, an impact-aware swing leg trajectory for a leg that starts to swing at the next moment, to enable an influence caused by an early collision to be within a target constraint range; and
performing, based on the movement state, the reference state sequence, and the foot-end reference state, whole-body control on the legged robot, and performing, based on a whole-body dynamic model and the discrete collision model, impact-aware whole-body control for a leg that is a supporting leg in planning but does not touch the ground, to enable an influence caused by a delayed collision to be within the target constraint range.

2. The planning and control method for the legged robot according to claim 1, wherein the foot-end dynamic model is:
$${Λ}_{c , l} {\ddot{x}}_{c , l} + {h}_{c , l} = {F}_{j} ,$$
where x_{c,l}∈ [symbol] is a linear acceleration of a foot end of an l-th leg in an inertial system I, Λ_{c,l} is a mass matrix in an operation space, h_{c,l} is a term comprising a Coriolis force, a centripetal force, and a gravitational force in the operation space, and Fⱼ∈ [symbol] is a foot-end driving force obtained by mapping a torque τⱼ of a driving joint to the operation space; and
the discrete collision model is:
$$Δ {\dot{x}}_{c , l} = {P}_{n} ( {\dot{x}}_{1}^{+} - {\dot{x}}_{1}^{-} ) = - ( 1 + {c}_{r} ) {P}_{n} {\dot{x}}_{c , l}^{-} ,$$
where Pₙ=nn^{T}∈ [symbol] is a projection operator on a collision normal vector, n∈ [symbol] is a unit normal vector of a collision surface,
$${\dot{x}}_{1}^{+} , {\dot{x}}_{1}^{-} ∈$$
are a velocity of a first object before collision and a velocity of the first object after the collision respectively,
$${\dot{x}}_{2}^{+} , {\dot{x}}_{2}^{-} ∈$$
are a velocity of a second object before collision and a velocity of the second object after the collision respectively, cᵣ is a restitution coefficient,
$${\dot{x}}_{c , l}^{-}$$
is a velocity of the foot-end of the l-th leg before collision in the inertial system, and Δ\dot{x}_{c,l} is a velocity change amount between the velocity of the foot-end of the l-th leg before collision in the inertial system and a velocity of the foot-end of the l-th leg after collision in the inertial system.

3. The planning and control method for the legged robot according to claim 1, wherein said planning, based on the foot-end dynamic model and the discrete collision model, the impact-aware swing leg trajectory comprises:
obtaining a pre-defined state variable and a target constraint condition;
constructing, based on the foot-end dynamic model, the pre-defined state variable, and the target constraint condition, a continuous-time trajectory optimization problem for the leg that starts to swing at the next moment; and
discretizing the continuous-time trajectory optimization problem to obtain a discrete-time trajectory optimization problem for a foot end of a swing leg, and solving the discrete-time trajectory optimization problem to obtain the impact-aware swing leg trajectory.

4. The planning and control method for the legged robot according to claim 3, wherein:
the pre-defined state variable comprises one or more of: an initial state of the foot end of the swing leg, a touchdown state of the foot end of the swing leg, a swing duration, and a desired maximum height of the foot end of the swing leg from the ground; and
the target constraint condition comprises one or more of: a state equation equality constraint, a driving force inequality constraint, a trajectory height inequality constraint, an initial state equality constraint, a terminal state equality constraint, an impact-aware inequality constraint, and a terminal velocity direction inequality constraint.

5. The planning and control method for the legged robot according to claim 3, wherein:
an objective function of the continuous-time trajectory optimization problem is:
$${min}_{x ( t ) , u ( t )} {f}_{T O} = {‖ x ( {t}_{F} ) - [ \begin{matrix}{x}_{c , F}^{ref} \\ {\dot{x}}_{c , F}^{ref}\end{matrix} ] ‖}_{{Q}_{{x}_{F}}} + {\int }_{{t}_{0}}^{{t}_{F}} {‖ u ( τ ) ‖}_{{Q}_{u}} d τ + {\int }_{{t}_{{h}_{1}}}^{{t}_{{h}_{2}}} {‖ {z}_{c} ( τ ) - {z}_{h}^{ref} ‖}_{{Q}_{z}} d τ ,$$
where x(t) is a state vector about time t, u(t) is a control vector about time t, Qₓ_{_{F}}∈ [symbol] , Qᵤ∈ [symbol] , and Q_{z}∈ [symbol] are weight matrices (mostly diagonal matrices) with different dimensions, ∥a∥_{Q}=a^{T}Qa represents a weighted norm of a vector a under a weight matrix Q,
$${‖ x ( {t}_{F} ) - [ \begin{matrix}{x}_{c , F}^{ref} \\ {\dot{x}}_{c , F}^{ref}\end{matrix} ] ‖}_{{Q}_{{x}_{F}}}$$
reflects a task of a touchdown state of the foot end of the swing leg,
$${x}_{c , F}^{ref} ∈ and {\dot{x}}_{c , F}^{ref} ∈$$
are a known terminal position of the foot end of the swing leg and a known linear velocity of the foot end of the swing leg respectively,
$${\int }_{{t}_{0}}^{{t}_{F}} {‖ u ( τ ) ‖}_{{Q}_{u}} d τ$$
is a minimum control variable (i.e., a linear acceleration) in an entire swing process, and t₀=0, t_{F}=T_{sw}, where T_{sw} is a swing duration,
$${\int }_{{t}_{{h}_{1}}}^{{t}_{{h}_{2}}} {‖ {z}_{c} ( τ ) - {z}_{h}^{ref} ‖}_{{Q}_{z}} d τ$$
reflects a task of a maximum height of the swing leg from the ground, tₕ₁ and tₕ₂ are parameters specifying a time period to reach the maximum height, satisfying t₀≤tₕ₁≤th₂≤t_{F}, and z_{c} is a third component of the state variable, i.e., a component representing a height of the foot end from the ground in the state variable; and
the discrete-time trajectory optimization problem is:
$${min}_{U} {f}_{c , TO} = {‖ {x}_{N} - {x}_{N}^{ref} ‖}_{{Q}_{{x}_{N}}} + {\sum }_{k = 0}^{N - 1} {‖ {u}_{k} ‖}_{{Q}_{{u}_{K}}} + {\sum }_{k = {k}_{{h}_{1}}}^{{k}_{{h}_{2}}} {‖ {S}_{z} {x}_{k} - {z}_{h}^{ref} ‖}_{{Q}_{{z}_{k}}} ,$$
$$s . t . \underbrace{[ \begin{matrix}{x}_{c , k + 1} \\ {\dot{x}}_{c , k + 1}\end{matrix} ]}_{{x}_{k + 1}} = \underbrace{[ \begin{matrix}{I}_{3 \times 3} & Δ {tI}_{3 \times 3} \\ {0}_{3 \times 3} & {I}_{3 \times 3}\end{matrix} ]}_{A} \underbrace{[ \begin{matrix}{x}_{c , k} \\ {\dot{x}}_{c , k}\end{matrix} ]}_{{x}_{k}} + \underbrace{[ \begin{matrix}\frac{1}{2} Δ {t}^{2} {I}_{3 \times 3} \\ Δ {tI}_{3 \times 3}\end{matrix} ]}_{B} \underbrace{{\ddot{x}}_{c , k}}_{{u}_{k}} , k = 0 , 1 , … , N - 1 ,$$
$${f}_{min} \leq {Λ}_{c} {u}_{k} + {h}_{c} \leq {f}_{max} , k = 0 , 1 , … , N - 1 ,$$
$${z}_{c , min} \leq {S}_{z} {x}_{k} \leq {z}_{c , max} , k = 1 , 2 , … , N - 1 ,$$
$${x}_{0} = {x}_{0}^{fb} ,$$
$${S}_{z , \dot{z}} {x}_{N} = {S}_{z , \dot{z}} {x}_{N}^{ref} ,$$
$${ι}_{c , min} \leq {Λ}_{c} [ - ( 1 + {c}_{r} ) {P}_{n} {S}_{υ} {x}_{k} ] \leq {ι}_{c , max} , k = {k}_{imp} , {k}_{imp} + 1 , … , N ,$$
$$( {C}_{{ℓ}_{1}} + \frac{1}{cos {θ}_{c , max}} {D}_{n} ) {S}_{v} {\dot{x}}_{k} \leq {0}_{4 \times 1} , k = {k}_{imp} , {k}_{imp} + 1 , … , N ,$$
where N represents a total number of frames in the discrete-time trajectory optimization problem, S_{z} is a selection matrix used for selecting a position component of a state vector in a Z-axis direction, A is a state matrix in a state equation, B is an input matrix in the state equation, uₖ is a control variable of a k-th frame, ƒₘᵢₙ and ƒₘₐₓ are an artificially specified lower limit foot-end driving force and an artificially specified upper limit foot-end driving force in an operation space respectively, z_{c,min} and z_{c,max} are a minimum height of the swing leg from the ground and the maximum height of the swing leg from the ground respectively, S_{z,ż} is a selection matrix used for selecting the position component and a velocity component of the state vector in the Z-axis direction, l_{c,min} and l_{c,max} are an artificially specified lower limit of an allowable collision impulse and an artificially specified upper limit of the allowable collision impulse respectively, θ_{c,max} is an artificially specified maximum allowable angle between a velocity vector before touchdown of the foot end of the swing leg and a unit normal vector of a collision surface, [symbol] is a terminal velocity direction constraint matrix, Dₙ is a matrix formed by the unit normal vector of the collision surface, ƒ_{c,TO} is an objective function of the discrete-time trajectory optimization problem, x_{N} is a state vector of an N-th frame,
$${Z}_{h}^{ref}$$
is a reference value of the maximum height of the swing leg from the ground, x_{c,k+1} is a foot-end position state of a (k+1)-th frame, \dot{x}_{c,k+1} is a foot-end velocity state of the (k+1)-th frame, Δt is a time interval between adjacent frames, Λ_{c} is a mass matrix in the operation space, h_{c} is a term comprising a Coriolis force, a centripetal force, and a gravitational force in the operation space, xₖ is a state vector of the k-th frame,
$$U = {[ {u}_{0}^{T} , {u}_{1}^{T} , … , {u}_{N - 1}^{T} ]}^{T} ∈$$
is a vector composed of a control variable of each frame, Qₓ_{_{N}}∈ [symbol] , Qᵤ_{ₖ}∈ [symbol] , and Q_{z}_{ₖ}∈ [symbol] are diagonal weight matrices with different dimensions,
$${x}_{0}^{fb} = [ \begin{matrix}{x}_{c , 0}^{fb} \\ {\dot{x}}_{c , 0}^{fb}\end{matrix} ] ∈$$
is a feedback of a foot-end state (comprising a position and a velocity) at a current moment,
$${x}_{N}^{ref} = [ \begin{matrix}{x}_{c , F}^{ref} \\ {\dot{x}}_{c , F}^{ref}\end{matrix} ] ∈$$
is a reference terminal foot-end state (comprising the position and the velocity), S_{ν}=[0_{3×3}I_{3×3}]∈ [symbol] is a selection matrix of a foot-end linear velocity, kₕ_{₁} and kₕ_{₂} are an artificially specified start frame and an artificially specified end frame for maintaining a swing height, satisfying 0≤kₕ_{₁}≤kₕ_{₂}<N, and kᵢₘₚ is a start frame for enabling an impact-aware constraint and a terminal velocity direction constraint, satisfying 0≤kᵢₘₚ≤N.

6. The planning and control method for the legged robot according to claim 1, wherein an optimization problem of the whole-body control is:
$${min}_{χ} {\sum }_{i = 1}^{{n}_{task}} {‖ {W}_{i} ( {A}_{i} χ - {b}_{i} ) ‖}_{2}^{2} ,$$
$$s . t . {lb}_{j} \leq {C}_{j} χ \leq {ub}_{j} , j = 1 , 2 , … , {n}_{constraint} ,$$
where χ is an optimization variable of the optimization problem of the whole-body control, Aᵢ is a task matrix, bᵢ is a task vector, cⱼ is a constraint matrix, lbⱼ and ubⱼ are a lower constraint bound and an upper constraint bound, Wᵢ is a weight matrix, nₜₐₛₖ is a quantity of tasks, and n_{constraint} is a quantity of constraints.

7. The planning and control method for the legged robot according to claim 1, wherein
tasks processed simultaneously by the whole-body control comprise two or more of: a trunk trajectory tracking task, a foot-end trajectory tracking task, a foot-sole force tracking task, a task of minimizing variation of a joint torque, and a task of minimizing variation of a foot-sole force; and
constraints processed simultaneously by the impact-aware whole-body control comprise two or more of: a floating-base dynamic equality constraint, a foot-sole force inequality constraint, a joint output torque saturation inequality constraint, a joint rotational speed saturation inequality constraint, a joint output power saturation inequality constraint, and an impact-aware constraint.

8. The planning and control method for the legged robot according to claim 7, wherein said performing, based on the movement state, the reference state sequence, and the foot-end reference state, whole-body control on the legged robot comprises:
if a leg is a swing leg in planning, setting the foot-end trajectory tracking task as tracking the impact-aware swing leg trajectory, setting a target foot-sole force of the foot-sole force tracking task as a predetermined value, setting a foot-sole force constraint in the foot-sole force inequality constraint as a predetermined value, and disabling the impact-aware constraint;
if a leg is the supporting leg in planning and touches the ground, setting a target linear acceleration of the foot-end trajectory tracking task as a predetermined value, setting the target foot-sole force of the foot-sole force tracking task as a foot-sole force provided by MPC or another module, setting the foot-sole force constraint as a friction cone constraint, and disabling the impact-aware constraint; and
if a leg is a supporting leg in planning but does not touch the ground, setting a target of the foot-end trajectory tracking task as tracking a velocity pointing to a collision surface, setting the target foot-sole force of the foot-sole force tracking task as a predetermined value, setting the foot-sole force constraint as a predetermined value, and enabling the impact-aware constraint.

9. The planning and control method for the legged robot according to claim 1, wherein:
the whole-body dynamic model is:
$$M ( {q}_{g} ) \ddot{q} + h ( {q}_{g} , \dot{q} ) = [ \begin{matrix}{0}_{6 \times 1} \\ {τ}_{j}\end{matrix} ] + {J}_{c}^{T} ( {q}_{g} ) {F}_{c} ,$$
where M(q_{g})∈ [symbol] is a generalized mass matrix, h(q_{g},\dot{q})∈ [symbol] is a term comprising a Coriolis force, a centripetal force, and a gravitational force, τj∈ [symbol] represents an output torque of a driving joint, 0_{n×m} represents a zero matrix with a size of n×m,
$${J}_{c}^{T} ( {q}_{g} )$$
and F_{c} are an augmented Jacobian matrix formed by stacking a contact Jacobian matrix of each supporting leg and an augmented foot-sole force formed by stacking a ground reaction force on a foot sole of each supporting leg respectively, q_{g} is a generalized joint space position, \dot{q} is a generalized joint space velocity, \ddot{q} is a generalized joint space acceleration, and n_{q} is a dimension size of the generalized joint space acceleration \ddot{q}; and
expressions for a matrix and a vector of the impact-aware constraint are:
$$\begin{matrix}{C}_{6 , l} = [ - δ t ( 1 + {c}_{r} ) {Λ}_{c , l} ( {q}_{g}^{fb} ) {P}_{n} {J}_{c , l} ( {q}_{g}^{fb} ) {0}_{3 \times {n}_{F}} ] ∈ \\ {lb}_{6} = {ι}_{c , l , min} + ( 1 + {c}_{r} ) {Λ}_{c , l} ( {q}_{g}^{fb} ) {P}_{n} ( {J}_{c , l} ( {q}_{g}^{fb} ) {\dot{q}}^{fb} + δ t {\dot{J}}_{c , l} ( {q}_{g}^{fb} ) {\dot{q}}^{fb} ) ∈ \\ {ub}_{6} = {ι}_{c , l , max} + ( 1 + {c}_{r} ) {Λ}_{c , l} ( {q}_{g}^{fb} ) {P}_{n} ( {J}_{c , l} ( {q}_{g}^{fb} ) {\dot{q}}^{fb} + δ t {\dot{J}}_{c , l} ( {q}_{g}^{fb} ) {\dot{q}}^{fb} ) ∈ ,\end{matrix}$$
where l_{c,l,min}, l_{c,l,max}∈ [symbol] are an artificially specified lower limit of an allowable collision impulse and an artificially specified upper limit of the allowable collision impulse respectively, δt represents a time interval between a current moment and the next moment, C_{6,l} the matrix of the impact-aware constraint, lb₆ is a lower limit vector of the impact-aware constraint, ub₆ is an upper limit vector of the impact-aware constraint, n_{χ} is a dimension size of the optimization variable, a variable marked with fb in its top right corner represents that the variable is a feedback variable, J_{c,l} represent the contact Jacobian matrix of an l-th leg, \dot{J}_{c,l} is a derivative of the contact Jacobian matrix of the l-th leg with respect to time.

10. A legged robot, comprising:
a memory;
a processor; and
a computer program stored in the memory and executable on the processor, wherein the processor is configured to execute the program to implement a planning and control method for a legged robot, the method comprising:
obtaining a movement instruction and a movement state of the legged robot;
generating, based on the movement instruction and the movement state, a reference state sequence of the legged robot and a swing parameter of each leg at a next moment;
determining, based on the movement state and the swing parameter of each leg at the next moment, a foot-end reference state of each leg, and planning, based on a foot-end dynamic model and a discrete collision model, an impact-aware swing leg trajectory for a leg that starts to swing at the next moment, to enable an influence caused by an early collision to be within a target constraint range; and
performing, based on the movement state, the reference state sequence, and the foot-end reference state, whole-body control on the legged robot, and performing, based on a whole-body dynamic model and the discrete collision model, impact-aware whole-body control for a leg that is a supporting leg in planning but does not touch the ground, to enable an influence caused by a delayed collision to be within the target constraint range.

11. The legged robot according to claim 10, wherein the foot-end dynamic model is:
$${A}_{c , l} {\ddot{x}}_{c , l} + {h}_{c , l} = {F}_{j} ,$$
where \ddot{x}_{c,l}∈ [symbol] is a linear acceleration of a foot end of an l-th leg in an inertial system I, Λ_{c,l} is a mass matrix in an operation space, h_{c,l} is a term comprising a Coriolis force, a centripetal force, and a gravitational force in the operation space, and Fⱼ∈ [symbol] is a foot-end driving force obtained by mapping a torque τⱼ of a driving joint to the operation space; and
the discrete collision model is:
$$Δ {\dot{x}}_{c , l} = {P}_{n} ( {\dot{x}}_{1}^{+} - {\dot{x}}_{1}^{-} ) = - ( 1 + {c}_{r} ) {P}_{n} {\dot{x}}_{c , l}^{-} ,$$
where Pₙ=nn^{T}∈ [symbol] is a projection operator on a collision normal vector, n∈ [symbol] is a unit normal vector of a collision surface,
$${\dot{x}}_{1}^{+} , {\dot{x}}_{1}^{-} ∈$$
are a velocity of a first object before collision and a velocity of the first object after the collision respectively,
$${\dot{x}}_{2}^{+} , {\dot{x}}_{2}^{-} ∈$$
are a velocity of a second object before collision and a velocity of the second object after the collision respectively, cᵣ is a restitution coefficient,
$${\dot{x}}_{c , l}^{-}$$
is a velocity of the foot-end of the l-th leg before collision in the inertial system, and Δ\dot{x}_{c,l} is a velocity change amount between the velocity of the foot-end of the l-th leg before collision in the inertial system and a velocity of the foot-end of the l-th leg after collision in the inertial system.

12. The legged robot according to claim 10, wherein said planning, based on the foot-end dynamic model and the discrete collision model, the impact-aware swing leg trajectory comprises:
obtaining a pre-defined state variable and a target constraint condition;
constructing, based on the foot-end dynamic model, the pre-defined state variable, and the target constraint condition, a continuous-time trajectory optimization problem for the leg that starts to swing at the next moment; and
discretizing the continuous-time trajectory optimization problem to obtain a discrete-time trajectory optimization problem for a foot end of a swing leg, and solving the discrete-time trajectory optimization problem to obtain the impact-aware swing leg trajectory.

13. The legged robot according to claim 12, wherein:
the pre-defined state variable comprises one or more of: an initial state of the foot end of the swing leg, a touchdown state of the foot end of the swing leg, a swing duration, and a desired maximum height of the foot end of the swing leg from the ground; and
the target constraint condition comprises one or more of: a state equation equality constraint, a driving force inequality constraint, a trajectory height inequality constraint, an initial state equality constraint, a terminal state equality constraint, an impact-aware inequality constraint, and a terminal velocity direction inequality constraint.

14. The legged robot according to claim 12, wherein:
an objective function of the continuous-time trajectory optimization problem is:
$${min}_{x ( t ) , u ( t )} {f}_{T O} = {‖ x ( {t}_{F} ) - [ \begin{matrix}{x}_{c , F}^{ref} \\ {\dot{x}}_{c , F}^{ref}\end{matrix} ] ‖}_{{Q}_{{x}_{F}}} + {\int }_{{t}_{0}}^{{t}_{F}} {‖ u ( τ ) ‖}_{{Q}_{u}} d τ + {\int }_{{t}_{{h}_{1}}}^{{t}_{{h}_{2}}} {‖ {z}_{c} ( τ ) - {z}_{h}^{ref} ‖}_{{Q}_{z}} d τ ,$$
where x(t) is a state vector about time t, u(t) is a control vector about time t, Qₓ_{_{F}}∈ [symbol] , Qᵤ∈ [symbol] , and Q_{z}∈ [symbol] are weight matrices (mostly diagonal matrices) with different dimensions, ∥a∥_{Q}=a^{T}Qa represents a weighted norm of a vector a under a weight matrix Q,
$$Q , {‖ x ( {t}_{F} ) - [ \begin{matrix}{x}_{c , F}^{ref} \\ {\dot{x}}_{c , F}^{ref}\end{matrix} ] ‖}_{{Q}_{{x}_{F}}}$$
reflects a task of a touchdown state of the foot end of the swing leg,
$${x}_{c , F}^{ref} ∈ and {\dot{x}}_{c , F}^{ref} ∈$$
are a known terminal position of the foot end of the swing leg and a known linear velocity of the foot end of the swing leg respectively,
$${\int }_{{t}_{0}}^{{t}_{F}} {‖ u ( τ ) ‖}_{{Q}_{u}} d τ$$
is a minimum control variable (i.e., a linear acceleration) in an entire swing process, and t₀=0, t_{F}=T_{sw}, where T_{sw} is a swing duration,
$${\int }_{{t}_{{h}_{1}}}^{{t}_{{h}_{2}}} {‖ {z}_{c} ( τ ) - {z}_{h}^{ref} ‖}_{{Q}_{z}} d τ$$
reflects a task of a maximum height of the swing leg from the ground, tₕ₁ and tₕ₂ are parameters specifying a time period to reach the maximum height, satisfying t₀≤tₕ₁≤tₕ₂≤t_{F}, and z_{c} is a third component of the state variable, i.e., a component representing a height of the foot end from the ground in the state variable; and
the discrete-time trajectory optimization problem is:
$${min}_{U} {f}_{c , T O} = {‖ {x}_{N} - {x}_{N}^{r e f} ‖}_{{Q}_{{x}_{N}}} + {\sum }_{k = 0}^{N - 1} {‖ {u}_{k} ‖}_{{Q}_{{u}_{k}}} + {\sum }_{k = {k}_{{h}_{1}}}^{{k}_{{h}_{2}}} {‖ {S}_{z} {x}_{k} - {z}_{h}^{ref} ‖}_{{Q}_{{z}_{k}}} , s . t . {\underbrace{[ \begin{matrix}{x}_{c , k + 1} \\ {\dot{x}}_{c , k + 1}\end{matrix} ]}}_{{x}_{k + 1}} = {\underbrace{[ \begin{matrix}{I}_{3 \times 3} & Δ {tI}_{3 \times 3} \\ {0}_{3 \times 3} & {I}_{3 \times 3}\end{matrix} ]}}_{A} {\underbrace{[ \begin{matrix}{x}_{c , k} \\ {\dot{x}}_{c , k}\end{matrix} ]}}_{{x}_{k}} + {\underbrace{[ \begin{matrix}\frac{1}{2} Δ {t}^{2} {I}_{3 \times 3} \\ Δ {tI}_{3 \times 3}\end{matrix} ]}}_{B} {\underbrace{{\ddot{x}}_{c , k}}}_{{u}_{k}} , k = 0 , 1 , … , N - 1 ,$$
$${f}_{min} \leq {Λ}_{c} {u}_{k} + {h}_{c} \leq {f}_{max} , k = 0 , 1 , … , N - 1 , {z}_{c , min} \leq {S}_{z} {x}_{k} \leq {z}_{c , max} , k = 1 , 2 , … , N - 1 , {x}_{0} = {x}_{0}^{fb} , {S}_{z , \dot{z}} {{x}_{N}}_{{=}^{}} {S}_{z , \dot{z}} {x}_{N}^{ref} ,$$
$${ι}_{c , min} ⩽ {A}_{c} [ - ( 1 + {c}_{r} ) {P}_{n} {S}_{v} {x}_{k} ] ⩽ {ι}_{c , max} , k = {k}_{imp} , {k}_{imp} + 1 , … , N , ( {C}_{{ℓ}_{1}} + \frac{1}{cos {θ}_{c , max}} {D}_{n} ) {S}_{v} {\dot{x}}_{k} \leq {0}_{4 \times 1} , k = {k}_{imp} , {k}_{imp} + 1 , … , N ,$$
Where N represents a total number of frames in the discrete-time trajectory optimization problem, S_{z} is a selection matrix used for selecting a position component of a state vector in a Z-axis direction, A is a state matrix in a state equation, B is an input matrix in the state equation, uₖ is a control variable of a k-th frame, ƒₘᵢₙ and ƒₘₐₓ are an artificially specified lower limit foot-end driving force and an artificially specified upper limit foot-end driving force in an operation space respectively, z_{c,min} and z_{c,max} are a minimum height of the swing leg from the ground and the maximum height of the swing leg from the ground respectively, S_{z,ż} is a selection matrix used for selecting the position component and a velocity component of the state vector in the Z-axis direction, l_{c,min} and l_{c,max} are an artificially specified lower limit of an allowable collision impulse and an artificially specified upper limit of the allowable collision impulse respectively, θ_{c,max} is an artificially specified maximum allowable angle between a velocity vector before touchdown of the foot end of the swing leg and a unit normal vector of a collision surface, [symbol] is a terminal velocity direction constraint matrix, Dₙ is a matrix formed by the unit normal vector of the collision surface, ƒ_{c,T0} is an objective function of the discrete-time trajectory optimization problem, x_{N} is a state vector of an N-th frame,
$${z}_{h}^{ref}$$
is a reference value of the maximum height of the swing leg from the ground, x_{c,k+1} is a foot-end position state of a (k+1)-th frame, \dot{x}_{c,k+1} is a foot-end velocity state of the (k+1)-th frame, Δt is a time interval between adjacent frames, Λ_{c} is a mass matrix in the operation space, h_{c} is a term comprising a Coriolis force, a centripetal force, and a gravitational force in the operation space, xₖ is a state vector of the k-th frame,
$$U = {[ {u}_{0}^{T} , {u}_{1}^{T} , … , {u}_{N - 1}^{T} ]}^{T} ∈$$
is a vector composed of a control variable of each frame, Qₓ_{_{N}}∈ [symbol] , Qᵤ_{ₖ}∈ [symbol] , and Q_{z}_{ₖ}∈ [symbol] are diagonal weight matrices with different dimensions,
$${x}_{0}^{fb} = [ \begin{matrix}{x}_{c , 0}^{fb} \\ {\dot{x}}_{c , 0}^{fb}\end{matrix} ] ∈$$
is a feedback of a foot-end state (comprising a position and a velocity) at a current moment,
$${x}_{N}^{ref} = [ \begin{matrix}{x}_{c , F}^{ref} \\ {\dot{x}}_{c , F}^{ref}\end{matrix} ] ∈$$
is a reference terminal foot-end state (comprising the position and the velocity), S_{ν}=[0_{3×3}I_{3×3}]∈ [symbol] is a selection matrix of a foot-end linear velocity, kₕ_{₁} and kₕ_{₂} are an artificially specified start frame and an artificially specified end frame for maintaining a swing height, satisfying 0<kₕ_{₁}≤kₕ_{₂}<N, and kᵢₘₚ is a start frame for enabling an impact-aware constraint and a terminal velocity direction constraint, satisfying 0≤kᵢₘₚ≤N.

15. The legged robot according to claim 10, wherein an optimization problem of the whole-body control is:
$${min}_{χ} {\sum }_{i = 1}^{{n}_{task}} {‖ {W}_{i} ( {A}_{i} χ - {b}_{i} ) ‖}_{2}^{2} ,$$
$$s . t . {lb}_{j} \leq {C}_{j} χ \leq {ub}_{j} , j = 1 , 2 , … , {n}_{constraint} ,$$
where χ is an optimization variable of the optimization problem of the whole-body control, Aᵢ is a task matrix, bᵢ is a task vector, cⱼ is a constraint matrix, lbⱼ and ubⱼ are a lower constraint bound and an upper constraint bound, Wᵢ is a weight matrix, nₜₐₛₖ is a quantity of tasks, and n_{constraint} is a quantity of constraints.

16. The legged robot according to claim 10, wherein
tasks processed simultaneously by the whole-body control comprise two or more of a trunk trajectory tracking task, a foot-end trajectory tracking task, a foot-sole force tracking task, a task of minimizing variation of a joint torque, and a task of minimizing variation of a foot-sole force; and
constraints processed simultaneously by the impact-aware whole-body control comprise two or more of: a floating-base dynamic equality constraint, a foot-sole force inequality constraint, a joint output torque saturation inequality constraint, a joint rotational speed saturation inequality constraint, a joint output power saturation inequality constraint, and an impact-aware constraint.

17. The legged robot according to claim 16, wherein said performing, based on the movement state, the reference state sequence, and the foot-end reference state, whole-body control on the legged robot comprises:
if a leg is a swing leg in planning, setting the foot-end trajectory tracking task as tracking the impact-aware swing leg trajectory, setting a target foot-sole force of the foot-sole force tracking task as a predetermined value, setting a foot-sole force constraint in the foot-sole force inequality constraint as a predetermined value, and disabling the impact-aware constraint;
if a leg is the supporting leg in planning and touches the ground, setting a target linear acceleration of the foot-end trajectory tracking task as a predetermined value, setting the target foot-sole force of the foot-sole force tracking task as a foot-sole force provided by MPC or another module, setting the foot-sole force constraint as a friction cone constraint, and disabling the impact-aware constraint; and
if a leg is a supporting leg in planning but does not touch the ground, setting a target of the foot-end trajectory tracking task as tracking a velocity pointing to a collision surface, setting the target foot-sole force of the foot-sole force tracking task as a predetermined value, setting the foot-sole force constraint as a predetermined value, and enabling the impact-aware constraint.

18. The legged robot according to claim 10, wherein:
the whole-body dynamic model is:
$$M ( {q}_{g} ) \ddot{q} + h ( {q}_{g} , \dot{q} ) = [ \begin{matrix}{0}_{6 \times 1} \\ {τ}_{j}\end{matrix} ] + {J}_{c}^{T} ( {q}_{g} ) {F}_{c} ,$$
where M(q_{g})∈ [symbol] is a generalized mass matrix, h(q_{g},\dot{q})∈ [symbol] is a term comprising a Coriolis force, a centripetal force, and a gravitational force, τj∈ [symbol] represents an output torque of a driving joint, 0_{n×m} represents a zero matrix with a size of n×m,
$${J}_{c}^{T} ( {q}_{g} )$$
and F_{c} are an augmented Jacobian matrix formed by stacking a contact Jacobian matrix of each supporting leg and an augmented foot-sole force formed by stacking a ground reaction force on a foot sole of each supporting leg respectively, q_{g} is a generalized joint space position, \dot{q} is a generalized joint space velocity, \ddot{q} is a generalized joint space acceleration, and n_{q} is a dimension size of the generalized joint space acceleration \ddot{q}; and
expressions for a matrix and a vector of the impact-aware constraint are:
$${C}_{6 , l} = [ - δ τ ( 1 + {c}_{r} ) {Λ}_{c , l} ( {q}_{g}^{fb} ) {P}_{n} {J}_{c , l} ( {q}_{g}^{fb} ) {0}_{3 \times {n}_{F}} ] ∈ ,$$
$${lb}_{6} = {ι}_{c , l , min} + ( 1 + {c}_{r} ) {Λ}_{c , l} ( {q}_{g}^{fb} ) {P}_{n} ( {J}_{c , l} ( {q}_{g}^{fb} ) {\dot{q}}^{fb} + δ t {\dot{J}}_{c , l} ( {q}_{g}^{fb} ) {\dot{q}}^{fb} ) ∈ ,$$
$${ub}_{6} = {ι}_{c , l , max} + ( 1 + {c}_{r} ) {Λ}_{c , l} ( {q}_{g}^{fb} ) {P}_{n} ( {J}_{c , l} ( {q}_{g}^{fb} ) {\dot{q}}^{fb} + δ t {\dot{J}}_{c , l} ( {q}_{g}^{fb} ) {\dot{q}}^{fb} ) ∈ ,$$
where l_{c,l,min}, l_{c,l,max}∈ [symbol] are an artificially specified lower limit of an allowable collision impulse and an artificially specified upper limit of the allowable collision impulse respectively, δt represents a time interval between a current moment and the next moment, C_{6,l} the matrix of the impact-aware constraint, lb₆ is a lower limit vector of the impact-aware constraint, ub₆ is an upper limit vector of the impact-aware constraint, n, is a dimension size of the optimization variable, a variable marked with fb in its top right corner represents that the variable is a feedback variable, J_{c,l} represent the contact Jacobian matrix of an l-th leg, \dot{J}_{c,l} is a derivative of the contact Jacobian matrix of the l-th leg with respect to time.

19. A non-transitory computer-readable storage medium, having a computer program stored thereon, wherein the program is configured to, when executed by a processor, implement a planning and control method for a legged robot, the method comprising:
obtaining a movement instruction and a movement state of the legged robot;
generating, based on the movement instruction and the movement state, a reference state sequence of the legged robot and a swing parameter of each leg at a next moment;
determining, based on the movement state and the swing parameter of each leg at the next moment, a foot-end reference state of each leg, and planning, based on a foot-end dynamic model and a discrete collision model, an impact-aware swing leg trajectory for a leg that starts to swing at the next moment, to enable an influence caused by an early collision to be within a target constraint range; and
performing, based on the movement state, the reference state sequence, and the foot-end reference state, whole-body control on the legged robot, and performing, based on a whole-body dynamic model and the discrete collision model, impact-aware whole-body control for a leg that is a supporting leg in planning but does not touch the ground, to enable an influence caused by a delayed collision to be within the target constraint range.
